(19) United States
(12) Patent Application Publication
(10) Pub. No.: US 2025/0358818 A1
(43) Pub. Date: Nov. 20, 2025

(54) COMMUNICATION METHOD AND TERMINAL DEVICE

(71) Applicant: BEIJING UNISOC COMMUNICATIONS TECHNOLOGY CO., LTD., Beijing (CN)

(72) Inventors: Zhongdan ZHANG, Beijing (CN); Huan ZHOU, Beijing (CN)

(21) Appl. No.: 18/870,616

(22) PCT Filed: May 30, 2023
(86) PCT No.: PCT/CN2023/097169

§ 371 Date: Nov. 29, 2024

(30) Foreign Application Priority Data
May 31, 2022 (CN) 202210611815.8

(51) Int. Cl. H04W 72/21; H04W 72/0453

(52) U.S. Cl. CPC H04W 72/21; H04W 72/0453

(57) ABSTRACT

Disclosed are a communication method and apparatus, a terminal device, a network device, and a chip, which relate to the field of communication technology. The method includes the following. Physical uplink shared channel (PUSCH) is sent on a first PUSCH resource; and the PUSCH is sent on a second PUSCH resource, where the second PUSCH resource is obtained by performing frequency hopping on the first PUSCH resource. A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the plurality of frequency-domain resources comprise at least one uplink frequency-domain resource and at least one downlink frequency-domain resource.

### CROSS-REFERENCE TO RELATED APPLICATION(S)

This application is a National Stage of International Application No. PCT/CN2023/097169, filed May 30, 2023, which claims priority to Chinese Patent Application No. 202210611815.8, filed May 31, 2022, the entire disclosures of which are incorporated herein by reference in their entireties.

### TECHNICAL FIELD

This disclosure relates to the field of communication technology, and in particular, to a communication method and apparatus, a terminal device, a network device, and a chip.

### BACKGROUND

Standard protocols specified by the 3rd generation partnership project (3GPP) introduce physical uplink shared channel (PUSCH) frequency hopping. The PUSCH frequency hopping may be understood as that PUSCH sent by a terminal device occupies a frequency band during a certain time period, but hops to another frequency band during a next time period.

At present, the existing protocol only stipulates that PUSCH frequency hopping on an active uplink bandwidth part (UL active BWP), and the UL BWP is considered as a frequency-domain resource supporting uplink transmission, that is, an uplink frequency-domain resource. However, with the evolution of standard protocols and communication scenarios, a new frequency-domain resource allocation method may be introduced. In the new frequency-domain resource allocation method, how to perform PUSCH frequency hopping needs to be further studied.

### SUMMARY

In a first aspect, a communication method is provided, and the method includes the following. Physical uplink shared channel (PUSCH) is sent on a first PUSCH resource. The PUSCH is sent on a second PUSCH resource, where the second PUSCH resource is obtained by performing frequency hopping on the first PUSCH resource. A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

In a second aspect, a communication method is provided, and the method includes the following. PUSCH is received on a first PUSCH resource. The PUSCH is received on a second PUSCH resource, where the second PUSCH resource is obtained by performing frequency hopping on the first PUSCH resource. A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

In a third aspect, a terminal device is provided in the present disclosure. The terminal device includes a processor, a memory, and a computer program or instruction stored in the memory. The processor is configured to execute the computer program or instruction to implement operations of the method in the first aspect.

### BRIEF DESCRIPTION OF THE DRAWINGS

To describe technical solutions in embodiments of the present disclosure more clearly, the following briefly introduces accompanying drawings required for the description of embodiments or the related art.

FIG. 1 is a schematic diagram of an architecture of a communication system provided in an embodiment of the present disclosure.

FIG. 2 is a schematic structural diagram of multiple frequency-domain resources in a time unit provided in an embodiment of the present disclosure.

FIG. 3 is a schematic structural diagram of frequency-domain resources for PUSCH frequency hopping provided in an embodiment of the present disclosure.

FIG. 4 is a schematic structural diagram of PUSCH frequency hopping among multiple frequency-domain resources provided in an embodiment of the present disclosure.

FIG. 5 is a schematic structural diagram of another PUSCH frequency hopping among multiple frequency-domain resources provided in an embodiment of the present disclosure.

FIG. 6 is a schematic structural diagram of another PUSCH frequency hopping among multiple frequency-domain resources provided in an embodiment of the present disclosure.

FIG. 7 is a schematic structural diagram of another PUSCH frequency hopping among multiple frequency-domain resources provided in an embodiment of the present disclosure.

FIG. 8 is a schematic structural diagram of another PUSCH frequency hopping among multiple frequency-domain resources provided in an embodiment of the present disclosure.

FIG. 9 is a schematic flowchart of a communication method provided in an embodiment of the present disclosure.

FIG. 10 is a block diagram of functional units of a communication apparatus provided in an embodiment of the present disclosure.

FIG. 11 is a block diagram of functional units of another communication apparatus provided in an embodiment of the present disclosure.

FIG. 12 is a schematic structural diagram of a terminal device provided in an embodiment of the present disclosure.

FIG. 13 is a schematic structural diagram of a network device provided in an embodiment of the present disclosure.

### DETAILED DESCRIPTION

It may be understood that the terms “first”, “second”, and the like involved in embodiments of the disclosure are used to distinguish different objects rather than describe a particular order. In addition, the terms “include”, “include”, and “have” as well as variations thereof are intended to cover non-exclusive inclusion. For example, a process, method, software, product, or device including a series of steps or units is not limited to the listed steps or units, on the contrary, it can include other steps or units that are not listed; or other steps or units inherent to the process, method, product, or device can be included either.

The term “embodiment” involved herein means that a particular feature, structure, or feature described in conjunction with the embodiments may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that the embodiments described herein may be combined with other embodiments.

The term “and/or” in embodiments of the disclosure illustrates an association relationship of associated objects, indicating that three relationships can exist, for example, A and/or B may mean A alone, both A and B exist, and B alone. A and B each may be a singular from or a plural form.

The character “/” herein may indicate that the associated objects are in an “or” relationship. In addition, the symbol “/” may represent a division sign, i.e. perform a division operation. For example, A/B can represent A divided by B.

The term “at least one (item) of” or the like in embodiments of the disclosure refers to any combination of these items, including any combination of a single item or multiple items. For example, at least one (item) of a, b, or c can represent the following seven cases: a; b; c; a and b; a and c; b and c; a, b, and c. a, b, and c each may be an element or a set including one or more elements.

The term “equal to” in embodiments of the disclosure can be used in conjunction with greater than and applicable to the technical solution used in the case of greater than; or can be used in conjunction with less than and applicable to the technical solution used in the case of less than. When equal to is used in conjunction with greater than, equal to is not in conjunction with less than. When equal to is used in conjunction with less than, equal to is not in conjunction with greater than.

In embodiments of the disclosure, the terms “of”, “corresponding, relevant”, “corresponding”, and “indicated” may sometimes be used interchangeably. It may be pointed out that meanings represented by the terms are consistent when differences therebetween are not emphasized.

The “connection” in embodiments of the disclosure refers to various manners of connection, such as direct connection or indirect connection, so as to implement communication between devices, which is not limited herein.

The terms “network” and “system” in embodiments of the disclosure can be expressed as the same concept, and a communication system is a communication network.

In embodiments of the present disclosure, “size” can be expressed as the same concept as “length”.

The following explains relevant content, concepts, meanings, technical problems, technical solutions, and beneficial effects involved in embodiments of this application.

### I. Communication System, Terminal Device, and Network Device

### 1. Communication System

The technical solutions of embodiments of the disclosure are applicable to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 6th-generation (6G) communication system, or other communication systems, etc.

It may be noted that a conventional wireless communication system generally supports a limited quantity of connections and therefore is easy to implement. However, with development of communication technology, a wireless communication system will not only support conventional wireless communication systems but also support, for example, device to device (D2D) communication, machine to machine (M2M) communication, machine type communication (MTC), vehicle to vehicle (V2V) communication, vehicle to everything (V2X) communication, a narrow band internet of things (NB-IoT), etc. Therefore, the technical solutions in embodiments of the disclosure can also be applied to the wireless communication systems above.

In addition, the technical solutions in embodiments of the disclosure may be applied to a beamforming scenario, a carrier aggregation (CA) scenario, a dual connectivity (DC) scenario, a standalone (SA) deployment scenario, etc.

In embodiments of the disclosure, the spectrum used for communication between terminal devices and network devices or the spectrum used for communication between terminal devices can be a licensed spectrum or an unlicensed spectrum, which is not limited herein. It may be noted that the unlicensed spectrum may be understood as a shared spectrum, and the licensed spectrum may be understood as a non-shared spectrum.

Since each embodiment is described in conjunction with a terminal device and a network device in embodiments of the disclosure, the following provides a specific description of involved terminal devices and network devices.

### 2. Terminal Device

In embodiments of the present disclosure, the terminal device may be a device with transmitting and receiving functions. The terminal device may also be referred to as a terminal, a user equipment (UE), a remote UE, a relay UE, an access terminal, a subscriber unit, a subscriber station, a mobile station, a remote station, a mobile device, a user terminal, a smart terminal, a wireless communication device, a user agent, a user apparatus, etc. It may be noted that relay UE is a terminal device that can provide relay forwarding services to other terminal devices (including remote UEs).

The terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In some possible embodiments, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

In addition, the terminal device may also be referred to as a cellular radio telephone, a cordless telephone, a session initiation protocol (SIP) telephone, a wireless local loop (WLL) station, a personal digital assistant (PDA), a device with wireless communication functions such as a handheld device, a computing device, or other processing devices coupled with a wireless modem, an in-vehicle device, a wearable device, and a terminal in a next-generation communication system (for example, an NR communication system or a 6G communication system), a terminal in a future evolved public land mobile network (PLMN), etc., which is not specifically limited herein.

The terminal may include an apparatus with wireless communication functions, such as a chip system, a chip, a chip module, etc. The chip system may include a chip and other discrete devices.

### 3. Network Device

In embodiments of the present disclosure, the network device may be a device with transmitting and receiving functions. The network device may be a device used for communication with terminal devices, responsible for radio resource management (RRM), quality of service (QoS) management, data compression and encryption, data transmission and reception at the air interface side. The network device may be a base station (BS) in the communication system or a device deployed in a radio access network (RAN) to provide wireless communication functions, for example, a base transceiver station (BTS) in the GSM or CDMA communication system, a node B (NB) in the WCDMA communication system, an evolved node B (eNB or eNodeB) in the LTE communication system, a next generation evolved node B (ng-eNB) in the NR communication system, a next generation node B (gNB) in the NR communication system, a master node (MN) in a dual link architecture, or a second node or a secondary node (SN) in the dual link architecture, which is not specifically limited herein.

In some possible embodiments, the network device may be devices in a core network (CN), such as access and mobility management function (AMF), user plan function (UPF), etc. The network device may also be an access point (AP) in the WLAN, a relay station, a communication device in the future evolved PLMN, a communication device in the NTN, etc.

In some possible embodiments, the network device may include an apparatus with wireless communication functions, such as a chip system, a chip, a chip module, etc. The chip system may include a chip and other discrete devices.

In some possible embodiments, the network device can also communicate with an internet protocol (IP) network, for example, the internet, a private IP network, or other data networks.

In some deployments, the network device may be an independent node to implement all functions of the above BS. The network device may include a centralized unit (CU) and a distributed unit (DU), such as a gNB-CU and a gNB-DU. The network device may further include an active antenna unit (AAU). The CU implements some functions of the network device, and the DU implements some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a medium access control (MAC) layer, and functions of a PHY layer. In addition, the AAU implements some PHY layer processing functions, radio frequency processing functions, and active-antenna related functions. Since RRC layer information will eventually become PHY layer information, or is transformed from PHY layer information, in this network deployment, it may be considered that higher-layer signaling (such as RRC layer signaling) is transmitted by the DU, or transmitted by both the DU and the AAU. It may be understood that, the network device may include at least one of the CU, the DU, or the AAU. In addition, the CU may be categorized as a network device in the RAN, or may be categorized as a network device in the CN, which is not specifically limited herein.

In some possible embodiments, the network device may be any one of multiple sites that perform coherent and cooperative transmission with the terminal device, or another site outside the multiple sites, or another network device that performs network communication with the terminal device, which is not specifically limited herein. The multi-site coherent joint transmission may be that multiple sites perform joint coherent transmission, or different data belonging to the same physical downlink shared channel (PDSCH) is sent from different sites to a terminal device, or multiple sites are virtualized into one site for transmission, and names with the same meaning specified in other standards are also applicable to the present disclosure, that is, the present disclosure does not limit the names of these parameters. A site in multi-site coherent joint transmission may be a remote radio head (RRH), a transmission and a transmission and reception point (TRP), a network device, and the like, which is not specifically limited herein.

In some possible embodiments, the network device may be any one of multiple sites that perform incoherent and cooperative transmission with the terminal device, or another site outside the multiple sites, or another network device that performs network communication with the terminal device, which is not specifically limited herein. The multi-site incoherent joint transmission may be that multiple sites perform joint incoherent transmission, or different data belonging to the same PDSCH is sent from different sites to a terminal device, and names with the same meaning specified in other standards are also applicable to the present disclosure, that is, the present disclosure does not limit the names of these parameters. A site in multi-site incoherent joint transmission may be an RRH, a transmission and a TRP, a network device, and the like, which is not specifically limited herein.

In some possible embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In some possible embodiments of the disclosure, the network device may provide a service for a cell, and the terminal device in the cell may communicate with the network device through transmission resources (for example, spectrum resources). The cell may include a macro cell, a small cell, a metro cell, a micro cell, a pico cell, a femto cell, etc.

### 4. Description of Example

The following exemplarily illustrates a wireless communication system in embodiments of the disclosure.

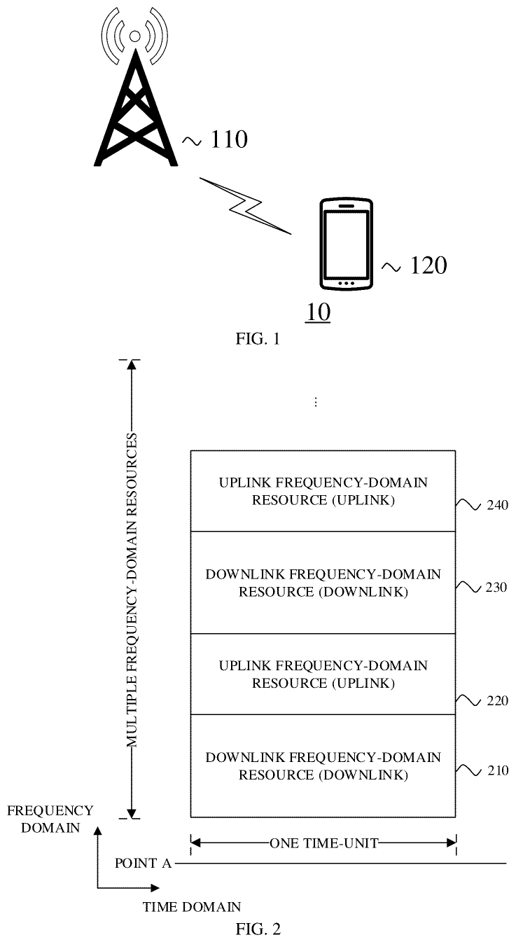

Exemplarily, for a network architecture of the wireless communication system in embodiments of the disclosure, reference can be made to FIG. 1. As illustrated in FIG. 1, the wireless communication system 10 may include a network device 110 and a terminal device 120. The network device 110 may communicate with the terminal device 120 through a wireless manner.

FIG. 1 is only an example of the network architecture of the wireless communication system, and does not constitute a limitation on the network architecture of the communication system in embodiments of the disclosure. For example, in embodiments of the disclosure, the wireless communication system may further include a processor or other devices. For example, in embodiments of the disclosure, the wireless communication system may include multiple network devices and/or multiple terminal devices.

### II. Physical Uplink Shared Channel (PUSCH)

In embodiments of the present disclosure, the terminal device may determine PUSCH resource allocation in frequency domain through resource indication information (for example higher-layer signalling or downlink control information (DCI)).

For example, for a scheduled (or triggered) PUSCH, the terminal device may determine PUSCH resource allocation in frequency domain through a frequency-domain resource assignment (FDRA) field in DCI carried by a physical downlink control channel (PDCCH).

For another example, for a configured grant PUSCH, the terminal device may determine, through higher-layer signaling (for example, a higher-layer parameter ConfiguredGrantConfig), PUSCH resource allocation in frequency domain for configured grant type 1 (CG Type 1).

PUSCH resource allocation in frequency domain supports 3 frequency domain allocation types, that is, type 0, type 1, and type 2.

### 1, Type 0

In Type 0, multiple contiguous resource blocks (RB) are bundled to one resource block group (RBG), and PUSCH resource allocation in frequency domain is performed only in units of RBG.

In type 0, DCI indicates an RBG in the frequency-domain resources allocating PUSCH for the terminal device by way of bitmap. The RBGs are numbered starting from the lowest frequency of BWP in increasing order of frequency of BWP. Because of the bitmap, different allocated RBGs are not necessarily contiguous.

In addition, type 0 does not support PUSCH frequency hopping.

### 2. Type 1

In Type 1, PUSCH resource allocation in frequency domain is not dependent on bitmap, but is determined by a starting position (e. g., RBₛₜₐᵣₜ) and the size of contiguous RBs. Therefore, unlike type 0, type 1 does not support any type of RB allocation, but only supports allocation of contiguous frequency-domain resources, thereby reducing signaling overhead of frequency-domain resource allocation.

In addition, Type 1 supports PUSCH frequency hopping.

### 3. Type 2

It should be noted that type 0 and type 1 are applicable to licensed spectra, while type 2 is applicable to unlicensed spectra.

In addition, Type 2 does not support PUSCH frequency hopping.

### III. PUSCH Frequency Hopping Procedure

### 1. PUSCH Frequency Hopping

PUSCH frequency hopping may be understood as that PUSCH sent by a terminal device occupies a frequency band at a certain moment, but hops to another frequency band at a next moment.

In the case of frequency-domain resource allocation type 1, if a frequency hopping field in a correspondingly detected DCI format or a random access response UL grant (RAR UL grant) is set to 1, the terminal device may perform PUSCH frequency hopping; or, for PUSCH transmission of CG type 1, a higher-layer parameter (e. g., frequencyHoppingOffset) are provided, and the terminal device may perform PUSCH frequency hopping. Otherwise, the terminal device does not perform PUSCH frequency hopping.

### 2. Frequency Hopping Mode

Sufficient frequency selective gain and interference randomization effects can be achieved through PUSCH frequency hopping, where the frequency hopping mode may include intra-slot frequency hopping and inter-slot frequency hopping, and the frequency hopping mode may be configured through higher-layer signaling. For example, the frequency hopping mode is configured by frequencyHopping in higher-layer information pusch-Config.

### Intra-Slot Frequency Hopping

For intra-slot frequency hopping, PUSCH is transmitted on two hops in the same slot, and the two hops are respectively a first hop and a second hop. The two hops have a frequency-domain starting-position interval in frequency domain, which is referred to as frequency offset. The two hops contain different contiguous OFDM symbols in time domain.

Intra-slot frequency hopping can improve frequency diversity and interference suppression of one PUSCH transmission, and can be applicable to single-slot PUSCH transmission and multi-slot PUSCH transmission.

### Inter-Slot Frequency Hopping

For inter-slot frequency hopping, one slot may be regarded as one hop in time domain, and therefore PUSCH is transmitted on different slots. The PUSCH transmitted on different hops also has a frequency offset.

The inter-slot offset may be applicable to multi-slot PUSCH transmission, thereby improving frequency diversity and interference suppression between two PUSCH transmissions.

Frequency-Domain Starting Position of PUSCH Per Hop in UL active BWP

It should be noted that the frequency-domain starting position in the embodiments of the present disclosure may be a starting RB, a starting sub-carrier, and a starting resource element (RE), etc. The RB in embodiments of the present disclosure may be a physical resource block (PRB) or a virtual resource block (VRB), which is not specifically limited. The embodiments of the present disclosure are described below by taking an example that the frequency-domain starting position is the starting RB, and other cases can be understood analogously.

For intra-slot frequency hopping, the starting RB of PUSCH Per Hop in UL active BWP may be derived from the following formula:

$${RB}_{start} = \{ \begin{matrix}{RB}_{start} & i = 0 \\ ( {RB}_{start} + {RB}_{offset} ) mod {N}_{BWP}^{size} & i = 1\end{matrix} ,$$

where i=0 represents the first hop, i=1 represents the second hop, RBₛₜₐᵣₜ may be obtained according to the resource indication value (RIV) contained in the FDRA field, RB_{offset} represents a frequency offset between two hops, and

$${N}_{BWP}^{size}$$

represents the size of the UL BWP. For PUSCH without repeated transmission, during intra-slot frequency hopping, the number of OFDM symbols included in the first hop is

$$⌊ {N}_{symb}^{PUSCH} / 2 ⌋ ,$$

the number of OFDM symbols included in the second hop is

$${N}_{symb}^{PUSCH} - ⌊ {N}_{symb}^{PUSCH} / 2 ⌋ , {N}_{symb}^{PUSCH}$$

represents the size of OFDM symbol used for PUSCH transmission in a slot, and

$$⌊ {N}_{symb}^{PUSCH} / 2 ⌋$$

represents a floor function of

$${N}_{symb}^{PUSCH} / 2.$$

For inter-slot frequency hopping, in a slot numbered

$${n}_{s}^{μ}$$

in a radio frame, the starting RB of each hop may be derived from the following formula:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} , where {n}_{s}^{μ} mod 2 = 0$$

represents a slot with an even number, i. e., a first hop;

$${n}_{s}^{μ} mod 2 = 1$$

represents a slot with an odd number, i. e., a second hop, RB_{offset} represents a frequency offset between two hops, and

$${N}_{BWP}^{size}$$

represents the size of the UL active BWP.

### 4. Frequency Offset Between Two Hops

### 1). Dynamic Scheduling of PUSCH

With regard to a dynamically scheduled PUSCH, and a frequency-domain resource allocation type being type 1, if PUSCH frequency hopping is configured, an FDMA filed in DCI scheduling the PUSCH has N_{UL_hop} bits, and the N_{UL_hop} bits indicate a frequency offset.

The network device may determine a frequency hopping range of PUSCH by configuring the frequency offset. Multiple frequency offsets are configured through higher-layer information, and then one multiple frequency offset is indicated from the multiple frequency offsets by N_{UL_hop} bits in DCI.

For example, frequency offsets are configured by the higher-layer parameter frequencyHoppingOffsetLists in the higher-layer information pusch-Config, in which two or four frequency offsets are configured, and then one frequency offset is indicated from the two or four frequency offsets through DCI. Each frequency offset ranges from 1 to

$$( {N}_{B W P}^{s i z e} - 1 ) .$$

### 2) PUSCH of CG Type 2

With regard to PUSCH of CG type 2 activated by a DCI format 0_0/0_1, and a frequency-domain resource allocation type being type 1, multiple frequency offsets may be configured by higher-layer parameter frequencyHoppingOffsetLists in higher-layer information pusch-Config, and then one frequency offset is indicated from the multiple frequency offsets by N_{UL_hop} bits in DCI.

With regard to PUSCH of CG type 2 activated by a DCI format 0_2, and a frequency-domain resource allocation type being type 1, multiple frequency offsets may be configured by higher-layer parameter frequencyHoppingOffsetListsDCI-0-2 in higher-layer information pusch-Config, and then one frequency offset is indicated from the multiple frequency offsets by N_{UL_hop} bits in DCI.

### 3) PUSCH of CG Type 1

For PUSCH of CG type 1, the frequency offset is configured by the higher-layer parameter frequencyHoppinOffset in the higher-layer information rrC-ConfiguredUplinkGrant.

### 4) PUSCH Scheduled by RAR UL Grant or PUSCH Scheduled by DCI 0-0 Scrambled by Temporary Cell Radio Network Temporary Identity (TC-RNTI)

For PUSCH transmission with frequency hopping scheduled by RAR UL grant, or for PUSCH scheduled by DCI 0-0 scrambled by TC-RNTI, one frequency offset is indicated out by N_{UL_hop} bits in DCI.

### IV. New Frequency-Domain Resource Configuration Manner

### 1. New Frequency-Domain Resource Allocation Method

With the rapid increase of uplink service demands of users, higher requirements are put forward on the uplink coverage ratio, rate, and time delay of terminal devices in the network.

In an existing time division duplexing (TDD) system, transmission directions of network devices on the same time domain resource are the same. Generally, a network device in a TDD system configures a transmission direction with a slot as granularity.

For example, supposing that slot 0 and slot 1 are configured with a downlink transmission direction and slot 2 is configured with an uplink transmission direction, the network device can only perform downlink communication during slot 0 and slot 1 and is unable to perform uplink communication during slot 0 and slot 1, and the network device can only perform uplink communication during slot 2 and is unable to perform downlink communication during slot 2. For a terminal device that has an uplink service requirement, the terminal device is unable to send uplink data to the network device during slot 0 and slot 1, and has to wait for slot 2 to perform uplink communication.

In an existing full duplex system, uplink and downlink communications may be simultaneously performed between a network device and a terminal device.

Different from the existing TDD system and full duplex system, a new frequency-domain resource allocation method is introduced in embodiments of the present disclosure, that is, a transmission direction is configured with frequency-domain resources in one time-unit as granularity, so that different transmission methods may be simultaneously configured for different frequency-domain resources in one time-unit. In other words, both frequency-domain resources (i. e. uplink frequency-domain resources) supporting uplink transmission (an uplink communication direction) and frequency-domain resources (i. e. downlink frequency-domain resources) supporting downlink transmission (a downlink communication direction) exist in one time-unit, so that multiple frequency-domain resources in one time-unit include at least one uplink frequency-domain resource and at least one downlink frequency-domain resource, the uplink frequency-domain resources are contiguous in frequency domain, and the downlink frequency-domain resources are contiguous in frequency domain.

It should be noted that, when one time-unit is one slot, only the uplink transmission direction or the downlink transmission direction can be supported in one slot in the TDD system, while the uplink transmission direction and the downlink transmission direction can be simultaneously supported in one slot in embodiments of the present disclosure.

For example, as illustrated in FIG. 2, multiple frequency-domain resources are configured in one time-unit, the multiple frequency-domain resources are contiguous in frequency domain, and the multiple frequency-domain resources include downlink frequency-domain resource 210, uplink frequency-domain resource 220, downlink frequency-domain resource 230, and uplink frequency-domain resource 240. Downlink frequency-domain resource 210 is contiguous in frequency domain, uplink frequency-domain resource 220 is contiguous in frequency domain, downlink frequency-domain resource 230 is contiguous in frequency domain, and uplink frequency-domain resource 240 is contiguous in frequency domain.

In addition, in embodiments of the present disclosure, a frequency-domain starting position and the size of each frequency-domain resource in one time-unit may be configured by a network or pre-configured, so that multiple frequency-domain resources in one time-unit may be configured by configuring the frequency-domain starting position of each frequency-domain resource and the size of each frequency-domain resource.

In following embodiments of the present disclosure, the new frequency-domain resource allocation method is illustrated from the perspectives of the network device and the UE respectively.

### For a Network Device

The network device may configure a transmission direction by using frequency-domain resources in one time-unit as granularity, in other words, multiple frequency-domain resources may be configured in one time-unit, and transmission directions for different frequency-domain resource may be configured to be different. Thus, for the network device, both frequency-domain resources for uplink transmission (in the uplink communication direction) and frequency-domain resources for downlink transmission (in the downlink communication direction) may exist in the same time unit.

By indicating the frequency-domain resources configured based on the described configuration manner to the terminal device, the network device can simultaneously perform uplink transmission (uplink communication) and downlink transmission (downlink communication) with different terminal devices on different frequency-domain resources, which is beneficial to meet communication requirements of different terminal devices. In other words, different terminal devices under the management of the network device can perform uplink transmission and downlink transmission at the same time, so that the network device seems to be able to perform uplink and downlink communication at the same time, or the network device can be full-duplex.

### For a Terminal Device

The terminal device can only perform uplink transmission or downlink transmission on frequency-domain resources in one time-unit, and is unable to perform uplink and downlink transmission at the same time. That is, the terminal device can be half-duplex.

Different terminal devices may determine frequency-domain resources (i. e. available frequency-domain resources) that can be used by the terminal devices according to the resource indication information sent by the network device, and communicate with the network device by using respective available frequency-domain resources. Since the transmission direction is configured with the frequency-domain resources in one time-unit as granularity, different terminal devices can perform uplink communication or downlink communication with the network device on different frequency-domain resources at the same time.

For a terminal device having an uplink service requirement, if frequency-domain resources for uplink transmission are configured in a current time unit, it is unnecessary for the terminal device to wait for the next time unit configured for uplink transmission according to the solution in the related art, instead, the terminal device may send data using the frequency-domain resources configured by the network device for uplink transmission in the current time unit. Thus, uplink service transmission can be completed more quickly. In other words, for a terminal device having an uplink service requirement, the terminal device can use frequency-domain resources to perform uplink services more quickly, thereby greatly improving the flexibility of a communication mode of a TDD communication system.

In conclusion, advantage of configuring the transmission direction with the frequency-domain resources in one time-unit as granularity in embodiments of the present disclosure are that the network device can perform uplink transmission or downlink transmission with different terminal devices in the same time unit, which helps to meet communication requirements of different terminal devices. For a terminal device having an uplink service requirement, the terminal device can use frequency-domain resources to perform uplink services more quickly, thereby greatly improving the flexibility of a communication mode of a TDD communication system.

### 2. Time Unit

In embodiments of the present disclosure, a time unit may be understood as communication granularity in time domain. For example, the time unit may be a subframe, a slot, a symbol, or a mini-slot, which is not specifically limited herein.

In addition, a time unit in embodiments of the present disclosure may be at least one subframe, at least one slot, at least one symbol, or at least one mini-slot, which is not specifically limited.

For understanding of a time unit, since PUSCH frequency hopping in embodiments of the present disclosure may be intra-slot frequency hopping or inter-slot frequency hopping, when PUSCH frequency hopping is intra-slot frequency hopping, a time unit may be a slot; and when PUSCH frequency hopping is inter-slot hopping, a time-unit may be multiple slots, which is not specifically limited.

### 3. Frequency-Domain Resource

In the embodiments of the present disclosure, frequency-domain resources support configuration of different transmission directions, in other words, a frequency-domain resource can be configured to support transmission in an uplink direction (uplink transmission), and can also be configured to support transmission in a downlink direction (downlink transmission).

In embodiments of the present disclosure, the frequency-domain resource may be a sub-band, or may be a contiguous RB set.

It should be noted that the sub-band in embodiments of the present disclosure may be understood as a sub-band divided from a bandwidth. The bandwidth may be BWP, and each sub-band supports only uplink transmission or downlink transmission.

In some possible embodiments, the sub-bands may be configured on the BWP or on a carrier.

When the frequency-domain resource is a sub-band, the multiple frequency-domain resources in one time-unit may be multiple sub-bands in one time-unit.

The contiguous RB set in embodiments of the present disclosure may be understood as that each frequency-domain resource in one time-unit may be a contiguous RB set.

### 4. Available Frequency-Domain Resources and Unavailable Frequency-Domain Resources

It should be noted that the network device may configure the transmission direction with the frequency-domain resources in one time-unit as granularity. Among the multiple frequency-domain resources configured in one time-unit, some uplink frequency-domain resources are configured to a certain terminal device, and some other uplink frequency-domain resources are configured to another terminal device. For a terminal device, only uplink frequency-domain resources configured thereto are available to the terminal device. For ease of description, uplink frequency-domain resources configured for the terminal device are referred to as “available frequency-domain resources”. Downlink resources and uplink frequency-domain resources configured for other terminal devices are not available to the terminal device.

For example, in FIG. 2, the network device configures multiple frequency-domain resources in one time-unit, where the multiple frequency-domain resources are contiguous in frequency domain, and the multiple frequency-domain resources include downlink frequency-domain resource 210, uplink frequency-domain resource 220, downlink frequency-domain resource 230, and uplink frequency-domain resource 240. Uplink frequency-domain resource 220 is configured for terminal device 1, and uplink frequency-domain resource 240 is configured for terminal device 2. Therefore, for terminal device 1, terminal device 1 knows the existence of uplink frequency-domain resource 220 but does not know the existence of uplink frequency-domain resource 240, uplink frequency-domain resource 220 is an available frequency-domain resource for terminal device 1, uplink frequency-domain resource 240, downlink frequency-domain resource 210, and downlink frequency-domain resource 230 are unavailable frequency-domain resources for terminal device 1. For terminal device 2, terminal device 2 knows the existence of uplink frequency-domain resource 240 but does not know the existence of uplink frequency-domain resource 220, uplink frequency-domain resource 240 is an available frequency-domain resource for terminal device 2, and uplink frequency-domain resource 220, downlink frequency-domain resource 210, and downlink frequency-domain resource 230 are unavailable frequency-domain resource for terminal device 2.

In conclusion, in embodiments of the present disclosure, for a terminal device, only an uplink frequency-domain resource configured for the terminal device is an available frequency-domain resource for the terminal device, and other frequency-domain resources (including a downlink frequency-domain resource and an uplink frequency-domain resource configured for another terminal device) are all unavailable frequency-domain resources for the terminal device.

### 5. Range of Frequency-Domain Resources for PUSCH Frequency Hopping

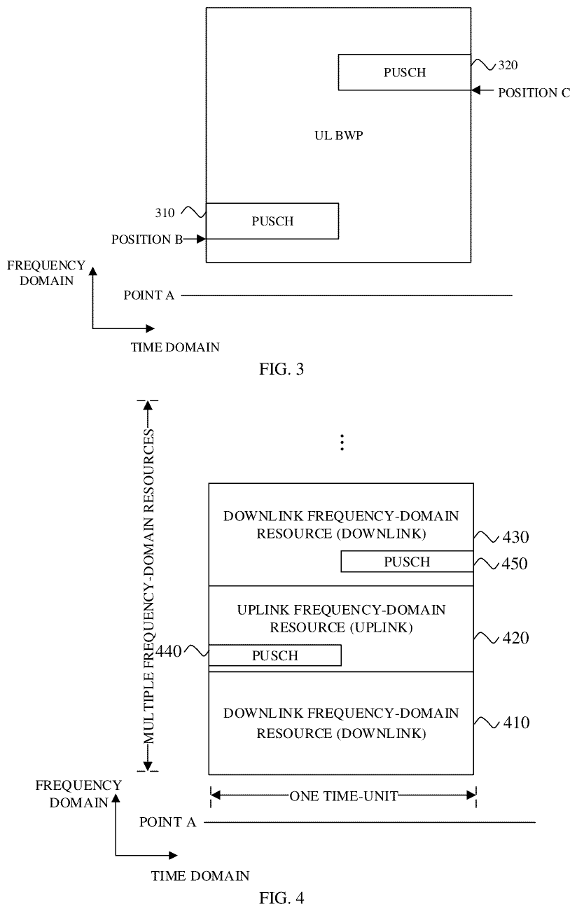

In conjunction with the described contents “III. PUSCH Frequency Hopping Procedure”, PUSCH frequency hopping can be performed in UL active BWP. For example, as illustrated in FIG. 3, PUSCH resource 310 is a first hop of PUSCH frequency hopping, and position B is a frequency-domain starting position of PUSCH resource 310; PUSCH resource 320 is a second hop of PUSCH frequency hopping, and position C is a frequency-domain starting position of PUSCH resource 320. Position B and Position C are numbered by using Point A as a reference point, in other words, Position B and Position C correspond to common resource block (CRB) indexes. In other embodiments, Position B and Position C are numbered by using a frequency-domain starting position of UL active BWP as a reference point, in other words, Position B and Position C correspond to physical resource blocks (PRB) indexes.

In embodiments of the present disclosure, a transmission direction is configured by using frequency-domain resources in a time unit as granularity, and uplink frequency-domain resources and downlink frequency-domain resources exist in the same time unit, so that the second hop of PUSCH frequency hopping may go beyond available frequency-domain resources, to be located in an unavailable frequency-domain resource, so that PUSCH transmission is unable to be performed, and therefore, a range of frequency-domain resources for PUSCH frequency hopping needs to be limited.

For example, unlike the case in FIG. 3 in which the second hop of PUSCH frequency hopping does not go beyond the UL BWP, in FIG. 4, multiple frequency-domain resources are configured in one time-unit, the multiple frequency-domain resources are contiguous in frequency domain, and the multiple frequency-domain resources include downlink frequency-domain resource 410, uplink frequency-domain resource 420, and downlink frequency-domain resource 430. Downlink frequency-domain resource 410 is contiguous in frequency domain, uplink frequency-domain resource 420 is contiguous in frequency domain, and downlink frequency-domain resource 430 is contiguous in frequency domain. Uplink frequency-domain resource 420 is an available frequency-domain resource for the terminal device, and the terminal device determines PUSCH resource 440 and PUSCH resource 450, where PUSCH resource 440 is a first hop of PUSCH frequency hopping, and PUSCH resource 450 is a second hop of PUSCH frequency hopping. Since PUSCH resource 440 is in uplink frequency-domain resource 420, PUSCH resource 450 is in downlink frequency-domain resource 430, and downlink frequency-domain resource 430 only supports downlink transmission, the terminal device is unable to send PUSCH on PUSCH resource 450.

### V. Limiting Range of Frequency-Domain Resources for PUSCH Frequency Hopping

Unlike the UL BWP, multiple frequency-domain resources being in one time-unit is introduced in embodiments of the present disclosure, the multiple frequency-domain resources include at least one uplink frequency-domain resource and at least one downlink frequency-domain resource. The second hop of PUSCH frequency hopping may go beyond available frequency-domain resources (an available frequency-domain resource is an uplink frequency-domain resource allocated thereto in the multiple frequency-domain resources), to be located in unavailable frequency-domain resources (the unavailable frequency-domain resources being a downlink frequency-domain resource in the multiple frequency-domain resources and uplink frequency-domain resources allocated to other terminal devices), so that the terminal device may fail to send PUSCH using the first hop and/or the second hop of PUSCH frequency hopping. In order to solve the problem that PUSCH transmission may fail to be performed by using PUSCH frequency hopping in a new frequency-domain resource configuration manner, in embodiments of the present disclosure, a frequency-domain starting position of each of two hops of PUSCH frequency hopping is enabled to be located in an available frequency-domain resource. Since the frequency-domain starting position of the second hop of PUSCH frequency hopping is located in an available frequency-domain resource, that is, a range of frequency-domain resources for PUSCH hopping in the multiple frequency-domain resources is limited, so that the second PUSCH resource may be normally used for communication, thereby solving the problem of how to perform frequency hopping on PUSCH under new frequency-domain resource allocation, and ensuring PUSCH transmission.

The technical solutions, beneficial effects, concepts and the like involved in embodiments of the present disclosure will be described below.

### 1. First PUSCH Resource and Second PUSCH Resource

### (1) Concept

The embodiments of the present disclosure relate to two hops of PUSCH frequency hopping. For ease of description, the first PUSCH resource may be a first hop PUSCH frequency hopping, the second PUSCH resource may be a second hop of PUSCH frequency hopping, in other words, the second PUSCH resource is obtained by performing frequency hopping on the first PUSCH resource.

In addition, intra-slot frequency hopping and inter-slot frequency hopping may be involved in embodiments of the present disclosure, the first PUSCH resource and the second PUSCH resource may be intra-slot PUSCH frequency hopping, and may be inter-slot PUSCH frequency hopping.

### (2) How to Determine First PUSCH Resource and Second PUSCH Resource

In embodiments of the present disclosure, a frequency-domain starting position of the first PUSCH resource and the size of the first PUSCH resource can be configured through network configuration or pre-configuration, so that the terminal device determines the first PUSCH resource according to the frequency-domain starting position of the first PUSCH resource and the size of the first PUSCH resource.

For example, taking network configuration as an example, for a scheduled (or triggered) PUSCH, the network device may indicate the frequency-domain starting position of the first PUSCH resource and the size of the first PUSCH resource to the terminal device through an RIV determined by the FDRA field in the DCI carried by the PDCCH.

In embodiments of the present disclosure, a frequency offset may be configured through network configuration or pre-configuration, and the frequency offset is an interval between the frequency-domain starting position of the first PUSCH resource and the frequency-domain starting position of the second PUSCH resource, so that the terminal device determines the frequency-domain starting position of the second PUSCH resource according to the frequency-domain starting position of the first PUSCH resource and the frequency offset. Alternatively, the terminal device may determine the frequency-domain starting position of the second PUSCH resource by itself without using any frequency offset, as long as the frequency-domain starting position of the second PUSCH resource is in the uplink frequency-domain resource.

For example, taking network configuration as an example, the network device may indicate the frequency offset by the value of N_{UL_hop} bits in the FDRA domain of the DCI carried by the PDCCH, or the network device may indicate the frequency offset by RRC signaling.

For the size of the second PUSCH resource, the size of the second PUSCH resource may be the same as the size of the first PUSCH resource, or may be configured through network configuration or pre-configuration. Therefore, the terminal device may determine the second PUSCH resource according to the size of the first PUSCH resource and the frequency-domain starting position of the second PUSCH resource, and may also determine the second PUSCH resource according to the size of the second PUSCH resource and the frequency-domain starting position of the second PUSCH resource, which is not specifically limited herein.

### (3) Frequency-Domain Starting Position of First PUSCH Resource and Frequency-Domain Starting Position of Second PUSCH Resource

In embodiments of the present disclosure, the frequency-domain starting position of the first PUSCH resource may represent the starting position of the first PUSCH resource in frequency domain. The frequency-domain starting position of the first PUSCH resource may be a starting RB of the first PUSCH resource, a starting subcarrier of the first PUSCH resource, or a starting RB of the first PUSCH resource, etc., which is not specifically limited thereto. The embodiments of the present disclosure will be described below by taking an example that the frequency-domain starting position of the first PUSCH resource is the starting RB first PUSCH resource, and other cases can be understood analogously.

The frequency-domain starting position of the second PUSCH resource may represent the starting position of the second PUSCH resource in frequency domain. By the same reasoning, the frequency-domain starting position of the second PUSCH resource may be a starting RB of the second PUSCH resource, a starting subcarrier of the second PUSCH resource, a starting RB of the second PUSCH resource, etc., which is not specifically limited.

The embodiments of the present disclosure will be described below by taking an example that the frequency-domain starting position of the second PUSCH resource is the starting RB of the second PUSCH resource, and other cases can be understood analogously.

In some possible embodiments, both the frequency-domain starting position of the first PUSCH resource and the frequency-domain starting position of the second PUSCH resource can be numbered by taking Point A as a reference point. In other possible embodiments, both the frequency-domain starting position of the first PUSCH resource and the frequency-domain starting position of the second PUSCH resource can be numbered by taking a frequency-domain starting position of UL active BWP as a reference point.

It should be noted that, since Point A is used as a common reference point of resource block grids, both the frequency-domain starting position of the first PUSCH resource and the frequency-domain starting position of the second PUSCH resource defined in the embodiments of the present disclosure use Point A as a reference point.

In some possible embodiments, the number of the frequency-domain starting position of the first PUSCH resource may be smaller than the number of the frequency-domain starting position of the second PUSCH resource, and may also be larger than the number of the frequency-domain starting position of the second PUSCH resource.

For example, in FIG. 4, the first PUSCH resource is PUSCH resource 440, and the second PUSCH resource is PUSCH resource 450. The number of the frequency-domain starting position of PUSCH resource 440 is less than the number of the frequency-domain starting position of PUSCH resource 450.

### (4) Size of First PUSCH Resource and Size of Second PUSCH Resource

In embodiments of the present disclosure, the size of the first PUSCH resource may be understood as a resource length or resource bandwidth occupied by the first PUSCH resource in frequency domain.

For example, the size of the first PUSCH resource may be the total number of RBs in the first PUSCH resource, the total number of subcarriers in the first PUSCH resource, the total number of REs in the first PUSCH resource, or the like, which is not specifically limited herein. The RB may be a PRB or a VRB.

The size of the second PUSCH resource may be understood as a resource length or resource bandwidth occupied by the second PUSCH resource in frequency domain.

For example, the size of the second PUSCH resource may be the total number of RBs in the second PUSCH resource, the total number of subcarriers in the second PUSCH resource, the total number of REs in the second PUSCH resource, or the like, which is not specifically limited.

### (5) Multiple Frequency-Domain Resources in One Time-Unit

For multiple frequency-domain resources in one time-unit, reference may be made to contents in “IV. new frequency-domain resource configuration manner”, each frequency-domain resource in the multiple frequency-domain resources is either an uplink frequency-domain resource or a downlink frequency-domain resource.

It may be noted that, in embodiments of the present disclosure, the multiple frequency-domain resources may be configured in one time-unit through network configuration or pre-configuration. In other words, uplink frequency-domain resources and downlink frequency-domain resources among the multiple frequency-domain resources are configured through network configuration or pre-configuration.

For example, taking network configuration as an example, higher-layer information may be used to configure a frequency-domain starting position of each frequency-domain resource (i. e. an uplink frequency-domain resource or a downlink frequency-domain resource) in the multiple frequency-domain resources and the size of each frequency-domain resource (i. e. an uplink frequency-domain resource or a downlink frequency-domain resource). Exemplarily, for a frequency-domain resource, a frequency-domain starting position and the size of the frequency-domain resource may be indicated by using one RIV, or one piece of indication information may indicate the frequency-domain starting position of the frequency-domain resource, and the other piece of indication information may indicate the size of the frequency-domain resource. The size of the frequency-domain resource may be the total number of RBs, the total number of subcarriers, the total number of REs, or the like, in the frequency-domain resource.

(6) Frequency-Domain Starting Position of First PUSCH Resource and Frequency-Domain Starting Position of Second PUSCH Resource (i.e. Frequency-Domain Starting Position of Each of Two Hops of PUSCH Frequency Hopping) being Located in Same Available Frequency-Domain Resource

In some possible embodiments, in embodiments of the present disclosure, the frequency-domain starting position of the first PUSCH resource and the frequency-domain starting position of the second PUSCH resource can be flexibly configured to be located in the same available frequency-domain resource, where the available frequency-domain resource is an uplink frequency-domain resource, so that PUSCH frequency hopping can be performed in the same available frequency-domain resource, to avoid the second hop of PUSCH in multiple frequency-domain resources in one time-unit from going beyond available frequency-domain resources, to achieve a possibility to limit the range of frequency-domain resources for PUSCH frequency hopping.

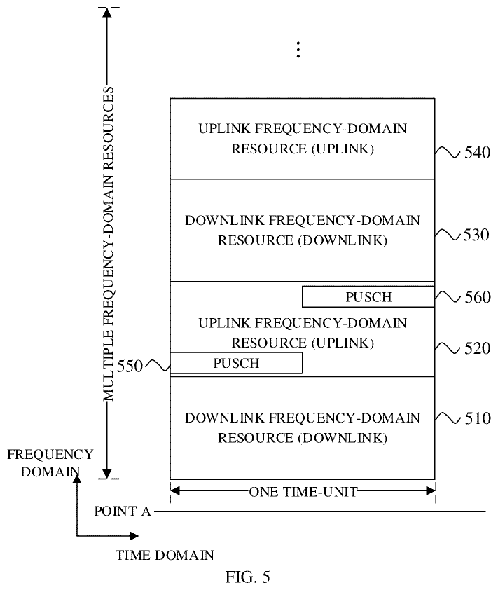

For example, as illustrated in FIG. 5, multiple frequency-domain resources are configured in one time-unit, the multiple frequency-domain resources are contiguous in frequency domain, and the multiple frequency-domain resources include downlink frequency-domain resource 510, uplink frequency-domain resource 520, downlink frequency-domain resource 530, and uplink frequency-domain resource 540. Uplink frequency-domain resource 520 is an available frequency-domain resource for the terminal device, and uplink frequency-domain resource 540 is an unavailable frequency-domain resource for the terminal device. The terminal device determines PUSCH resource 550 as a first PUSCH resource, and PUSCH resource 560 as the second PUSCH resource. A frequency-domain starting position of PUSCH resource 550 and a frequency-domain starting position of PUSCH resource 560 are both in uplink frequency-domain resource 520, and the frequency-domain starting position of the PUSCH resource 550 is smaller than the frequency-domain starting position of the PUSCH resource 560.

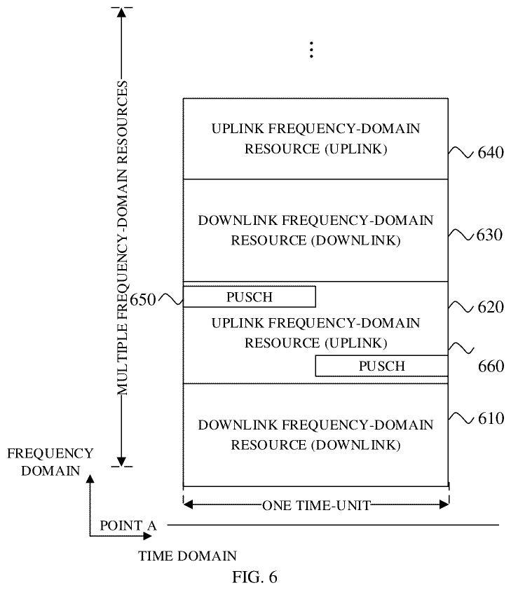

As another example, as illustrated in FIG. 6, multiple frequency-domain resources are configured in one time-unit, the multiple frequency-domain resources are contiguous in frequency domain, and the multiple frequency-domain resources include downlink frequency-domain resource 610, uplink frequency-domain resource 620, downlink frequency-domain resource 630, and uplink frequency-domain resource 640. Uplink frequency-domain resource 620 is an available frequency-domain resource for the terminal device, and the terminal device determines PUSCH resource 650 as a first PUSCH resource and PUSCH resource 660 as a second PUSCH resource. The frequency-domain starting position of PUSCH resource 650 and the frequency-domain starting position of PUSCH resource 660 are both in uplink frequency-domain resource 620, and the frequency-domain starting position of PUSCH resource 650 is greater than the frequency-domain starting position of PUSCH resource 660.

In addition, if the terminal device only supports one uplink frequency-domain resource, or the network device only configures one uplink frequency-domain resource for the terminal device (i. e. the one uplink frequency-domain resource is an available frequency-domain resource for the terminal device), by configuring the frequency-domain starting position of the first PUSCH resource and the frequency-domain starting position of the second PUSCH resource in the one uplink frequency-domain resource, the capability of the terminal device can be adapted, so that the terminal device can send PUSCH on the first PUSCH resource and the second PUSCH resource.

### (7) First Available Frequency-Domain Resource, Frequency-Domain Starting Position of First Available Frequency-Domain Resource, and Size of First Available Frequency-Domain Resource

If the network device only configures one available frequency-domain resource for the terminal device, the frequency-domain starting position of the first PUSCH resource and the frequency-domain starting position of the second PUSCH resource are located in one available frequency-domain resource.

For ease of description, in embodiments of the present disclosure, the one available frequency-domain resource may be referred to as “first available frequency-domain resource”. In other words, the first available frequency-domain resource may be one available frequency-domain resource. Similar to the description in the foregoing “(5) Multiple Frequency-Domain Resources in One Time-Unit”, in embodiments of the present disclosure, the frequency-domain starting position of the first available frequency-domain resource and the size of the first available frequency-domain resource may be configured through network configuration or pre-configuration. The size of the first available frequency-domain resource may be construed as a resource length or a resource bandwidth occupied by the first available frequency-domain resource in frequency domain.

For example, the size of the first available frequency-domain resource may be the total number of RBs, the total number of subcarriers, the total number of REs, or the like, in the first available frequency-domain resource.

(8) Frequency-Domain Starting Position of First PUSCH Resource and Frequency-Domain Starting Position of Second PUSCH Resource (i.e. Frequency-Domain Starting Position of Each of Two Hops of PUSCH Frequency Hopping) being Located in Different Available Frequency-Domain Resources

In some possible embodiments, in embodiments of the present disclosure, the frequency-domain starting position of the first PUSCH resource and the frequency-domain starting position of the second PUSCH resource can be flexibly configured to be located in different available frequency-domain resources, so that PUSCH frequency hopping can be implemented in different available frequency-domain resources, the second hop of the PUSCH frequency hopping is prevented from going beyond the available frequency-domain resources, and the possibility of limiting the range of frequency-domain resources for PUSCH frequency hopping is achieved.

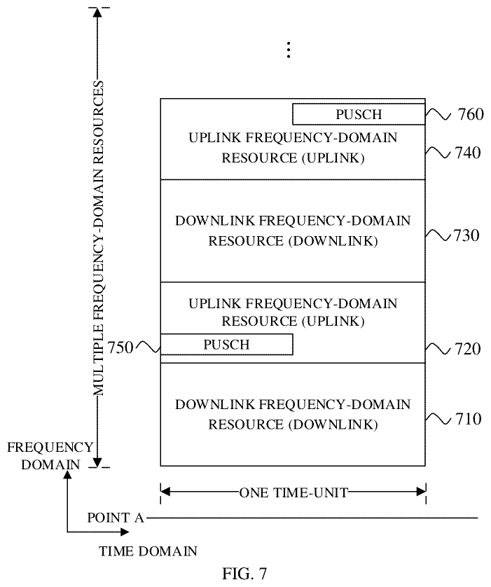

For example, as illustrated in FIG. 7, multiple frequency-domain resources are configured in one time-unit, the multiple frequency-domain resources are contiguous in frequency domain, and the multiple frequency-domain resources include downlink frequency-domain resource 710, uplink frequency-domain resource 720, downlink frequency-domain resource 730, and uplink frequency-domain resource 740. Uplink frequency-domain resource 720 is an available frequency-domain resource for the terminal device, and uplink frequency-domain resource 740 is another available frequency-domain resource for the terminal device. The terminal device determines PUSCH resource 750 as a first PUSCH resource, and PUSCH resource 760 as a second PUSCH resource, where a frequency-domain starting position of PUSCH resource 750 is in uplink frequency-domain resource 720, a frequency-domain starting position of PUSCH resource 760 is in uplink frequency-domain resource 740, and the frequency-domain starting position of PUSCH resource 750 is smaller than the frequency-domain starting position of the PUSCH resource 760.

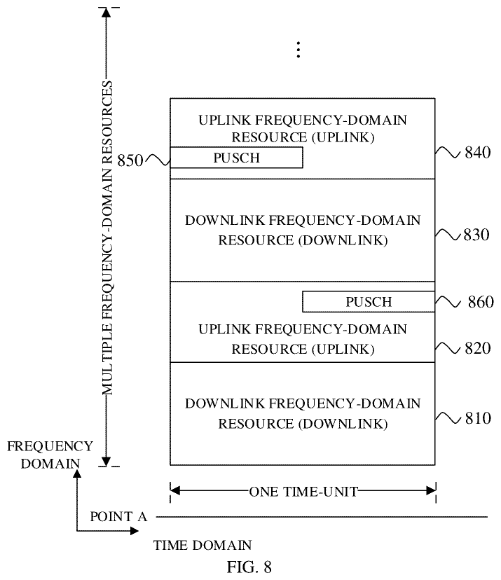

For another example, as illustrated in FIG. 8, multiple frequency-domain resources are configured in one time-unit, the multiple frequency-domain resources are contiguous in frequency domain, and the multiple frequency-domain resources include downlink frequency-domain resource 810, uplink frequency-domain resource 820, downlink frequency-domain resource 830, and uplink frequency-domain resource 840. Uplink frequency-domain resource 820 is an available frequency-domain resource for the terminal device, and uplink frequency-domain resource 840 is another available frequency-domain resource for the terminal device. The terminal device determines PUSCH resource 850 as a first PUSCH resource, and PUSCH resource 860 as a second PUSCH resource, where a frequency-domain starting position of PUSCH resource 850 is in uplink frequency-domain resource 840, a frequency-domain starting position of PUSCH resource 860 is in uplink frequency-domain resource 820, and the frequency-domain starting position of PUSCH resource 850 is greater than the frequency-domain starting position of PUSCH resource 860.

In addition, if the capability of the terminal device supports multiple uplink frequency-domain resources, or the network device configures the terminal device with multiple uplink frequency-domain resources (i. e. the multiple uplink frequency-domain resources are multiple available frequency-domain resources for the terminal device), by configuring the frequency-domain starting position of the first PUSCH resource and the frequency-domain starting position of the second PUSCH resource in different frequency-domain resources, the capability of the terminal device can be adapted to, so that the terminal device can send PUSCH on the first PUSCH resource and the second PUSCH resource.

### (9) Second Available Frequency-Domain Resource and Third Available Frequency-Domain Resource

If the network device configures the terminal device with multiple available frequency-domain resources, the frequency-domain starting position of the first PUSCH resource and the frequency-domain starting position of the second PUSCH resource may be located in the same or different available frequency-domain resources.

For ease of distinction and description, in embodiments of the present disclosure, an available frequency-domain resource where the frequency-domain starting position of the first PUSCH resource is located may be referred to as “second available frequency-domain resource”, and an available frequency-domain resource where the frequency-domain starting position of the second PUSCH resource is located may be referred to as “third available frequency-domain resource”. The second available frequency-domain resource and the third available frequency-domain resource may be two different available frequency-domain resources or the same available frequency-domain resource.

In other words, if the frequency-domain starting position of the first PUSCH resource and the frequency-domain starting position of the second PUSCH resource are located in the same available frequency-domain resource, the second available frequency-domain resource and the third available frequency-domain resource are the same available frequency-domain resource. If the frequency-domain starting position of the first PUSCH resource and the frequency-domain starting position of the second PUSCH resource are located in different available frequency-domain resources, the second available frequency-domain resource and the third available frequency-domain resource are different two available frequency-domain resources.

In some possible embodiments, the third available frequency-domain resource has the largest size among the multiple available frequency-domain resources except the second available frequency-domain resource.

It should be noted that, as the third available frequency-domain resource has the largest size among the multiple available frequency-domain resources except the second available frequency-domain resource, it can be ensured that the frequency-domain starting position of the second PUSCH resource (i. e. the second hop of PUSCH frequency hopping) is in a larger uplink frequency-domain resource, which helps to prevent the frequency-domain resource range of the second PUSCH resource from exceeding the larger uplink frequency-domain resource as far as possible.

In some possible embodiments, the third available frequency-domain resource may be any one among the multiple available frequency-domain resources except the second available frequency-domain resource, so that the frequency-domain resource range of the second PUSCH resource can be configured flexibly.

### (10) How to Determine Frequency-Domain Starting Position of Second PUSCH Resource

In conjunction with the described description, since the network device can configure one or more available frequency-domain resources for the terminal device, the frequency-domain starting position of the second PUSCH resource is determined in the following two situations.

### Case 1

### a) How to Determine Frequency-Domain Starting Position of Second PUSCH Resource

In “Case 1”, the network device configures one available frequency-domain resource for the terminal device, and a frequency-domain starting position of a first PUSCH resource and a frequency-domain starting position of a second PUSCH resource are in the first available frequency-domain resource. The frequency-domain starting position of the second PUSCH resource can be determined through network configuration, pre-configuration or protocol specified information (such as a frequency offset, etc.).

In a specific embodiment, the frequency-domain starting position of the second PUSCH resource can be autonomously determined by the terminal device; or the frequency-domain starting position of the second PUSCH resource may be determined by at least one of the frequency-domain starting position of the first PUSCH resource, the frequency-domain starting position of the first available frequency-domain resource, a frequency offset, and the size of the first available frequency-domain resource.

It can be understood that the terminal device may autonomously determine the frequency-domain starting position of the second PUSCH resource; or the terminal device may determine the frequency-domain starting position of the second PUSCH resource according to at least one of the frequency-domain starting position of the first PUSCH resource, the frequency-domain starting position of the first available frequency-domain resource, the frequency offset, and the size of the first available frequency-domain resource.

In addition, since PUSCH frequency hopping in embodiments of the present disclosure may be intra-slot frequency hopping, or inter-slot frequency hopping, how to determine the frequency-domain starting position of the second PUSCH resource according to the above information will be illustrated below respectively in the case of intra-slot frequency hopping and the case of inter-slot frequency hopping.

### Example 1

In a possible embodiment, for intra-slot frequency hopping, the frequency-domain starting position of the second PUSCH resource may be expressed as:

$$R {B}_{start}^{2} = ( {RB}_{start}^{1} - {N}_{a v a i l a b l e}^{start} + R {B}_{offset}^{1} ) mod {N}_{a v a i l a b l e}^{s i z e} . {RB}_{start}^{2}$$

represents a frequency-domain starting position of a second PUSCH resource,

$$R {B}_{start}^{1}$$

represents a frequency-domain starting position of a first PUSCH resource,

$${N}_{a v a i l a b l e}^{start}$$

represents frequency-domain starting position of a first available frequency-domain resource,

$$R {B}_{offset}^{1}$$

represents a frequency offset,

$${N}_{a v a i l a b l e}^{s i z e}$$

represents the size of the first available frequency-domain resource, and mod represents an modulo operation. In this embodiment,

$$R {B}_{start}^{2}$$

is the frequency-domain starting position of the second PUSCH resource with reference to the frequency-domain starting position of the first available frequency-domain resource.

In another possible embodiment, for intra-slot frequency hopping, the frequency-domain starting position of the second PUSCH resource may be expressed as:

$${RB}_{start}^{2} = {N}_{a v a i l a b l e}^{start} + ( R {B}_{start}^{1} - {N}_{a v a i l a b l e}^{start} + R {B}_{offset}^{1} ) mod {N}_{a v a i l a b l e}^{s i z e} .$$

$$R {B}_{start}^{2}$$

represents a frequency-domain starting position of a second PUSCH resource,

$$R {B}_{start}^{1}$$

represents a frequency-domain starting position of a first PUSCH resource,

$${N}_{a v a i l a b l e}^{start}$$

represents a frequency-domain starting position of a first available frequency-domain resource,

$$R {B}_{offset}^{1}$$

represents a frequency offset,

$${N}_{a v a i l able}^{s i z e}$$

represents the size of the first available frequency-domain resource, and mod represents an modulo operation. In this embodiment,

$$R {B}_{start}^{2}$$

is the frequency-domain starting position of the second PUSCH resource with reference to the start of UL active BWP.

Taking FIG. 5 as an example, a time unit is a slot,

$$R {B}_{start}^{2}$$

represents a frequency-domain starting position of PUSCH resource 560,

$$R {B}_{s t a r t}^{1}$$

represents a frequency-domain starting position of PUSCH resource 550,

$${N}_{a v a i l a b l e}^{s t a r t}$$

represents a frequency-domain starting position of uplink frequency-domain resource 520,

$$R {B}_{offset}^{1}$$

represents an interval of the frequency-domain starting position of PUSCH resource 550 and the frequency-domain starting position of PUSCH resource 560, and

$${N}_{a v a i l a b l e}^{s i z e}$$

represents the size of uplink frequency-domain resource 520.

It can be noted that, since Point A is used as a reference point for both

$$R {B}_{s t a r t}^{1} and {N}_{a v a i l a ble}^{s t a r t} ,$$

the reference point may be changed from Point A to

$${N}_{a v a i l a b l e}^{s t a r t}$$

through

$$R {B}_{s t a r t}^{1} - {N}_{u p l i n k}^{s t a r t} ,$$

and then

$${N}_{a v a i l a b l e}^{start}$$

is used as a reference point and added with

$$R {B}_{offset}^{1} ,$$

and a modulo operation is performed on the sum with

$${N}_{a v a i l a ble}^{s i z e} ,$$

so that

$$R {B}_{s t a r t}^{2}$$

may be obtained through calculation, and

$$R {B}_{s t a r t}^{2}$$

may be located in a first available frequency-domain resource, the possibility of limiting the range of frequency-domain resources for PUSCH frequency hopping may be achieved, and PUSCH frequency hopping may be implemented on multiple frequency-domain resources in one time-unit, so as to ensure the possibility of PUSCH transmission. In other embodiments, the start of UL active BWP can also be used as a reference point for both

$$R {B}_{s t a r t}^{1} and {N}_{a v a i l a b l e}^{s t a r t} ,$$

the reference point may be changed from the start of UL active BWP to

$${N}_{a v a i l a b l e}^{s t a r t}$$

through

$$R {B}_{s t a r t}^{1} - {N}_{u p l i n k}^{s t a r t} ,$$

and then

$${N}_{available}^{start}$$

is used as a reference point and added with

$${RB}_{offset}^{1} ,$$

and a modulo operation is performed on the sum with

$${N}_{available}^{size} ,$$

so that

$${RB}_{start}^{2}$$

may be obtained through calculation, and

$${RB}_{start}^{2}$$

may be located in a first available frequency-domain resource, the possibility of limiting the range of frequency-domain resources for PUSCH frequency hopping may be achieved, and PUSCH frequency hopping may be implemented on multiple frequency-domain resources in one time-unit, so as to ensure the possibility of PUSCH transmission.

### Example 2

For inter-slot frequency hopping, the frequency-domain starting position of the second PUSCH resource may be expressed with

$${RB}_{start}^{2} ( {n}_{s}^{μ} ) = ( {RB}_{start}^{1} - {N}_{available}^{start} + {RB}_{offset}^{1} ) mod {N}_{available}^{size} \cdot {n}_{s}^{μ} mod 2 = 0$$

$$or$$

$${n}_{s}^{μ} mod 2 = 1 \cdot {RB}_{start}^{2} ( {n}_{s}^{μ} )$$

represents a frequency-domain starting position of a second PUSCH resource during slot

$${n}_{s}^{μ} , {RB}_{start}^{1}$$

represents a frequency-domain starting position of a first PUSCH resource,

$${N}_{available}^{start}$$

represents a frequency-domain starting position of a first available frequency-domain resource,

$${RB}_{offset}^{1}$$

represents a frequency offset,

$${N}_{available}^{size}$$

represents the size of the first available frequency-domain resource, and mod represents a modulo operation. In this embodiment,

$${RB}_{start}^{2} ( {n}_{s}^{μ} )$$

is the frequency-domain starting position of the second PUSCH resource with reference to the frequency-domain starting position of the first available frequency-domain resource.

In another possible embodiment, for inter-slot frequency hopping, the frequency-domain starting position of the second PUSCH resource may be expressed with

$${RB}_{start}^{2} ( {n}_{s}^{μ} ) = {N}_{available}^{start} + ( {RB}_{start}^{1} - {N}_{available}^{start} + R {B}_{offset}^{1} ) mod {N}_{avai lable}^{size} \cdot {n}_{s}^{μ} mod 2 = 0$$

$$or$$

$${n}_{s}^{μ} mod 2 = 1 \cdot {RB}_{start}^{2} ( {n}_{s}^{μ} )$$

represents a frequency-domain starting position of a second PUSCH resource during slot

$${n}_{s}^{μ} , {RB}_{start}^{1}$$

represents a frequency-domain starting position of a first PUSCH resource,

$${N}_{available}^{start}$$

represents a frequency-domain starting position of a first available frequency-domain resource,

$${RB}_{offset}^{1}$$

represents a frequency offset,

$${N}_{available}^{size}$$

represents the size of the first available frequency-domain resource, and mod represents a modulo operation. In this embodiment,

$${RB}_{start}^{2} ( {n}_{s}^{μ} )$$

is the frequency-domain starting position of the second PUSCH resource with reference to the start of UL active BWP.

$$b ) {RB}_{offset}^{1}$$

In some possible embodiments, the value

$${RB}_{offset}^{1}$$

may range from 1 to

$$( {N}_{available}^{size} - 1 ) .$$

It may be noted that, by limiting the value

$${RB}_{offset}^{1}$$

ranging from 1 to

$$( {N}_{available}^{size} - 1 ) , {RB}_{offset}^{1}$$

may be enabled to be in

$${N}_{available}^{size} .$$

In this way, after

$${RB}_{offset}^{1}$$

is added, it is beneficial to enable

$${RB}_{start}^{2}$$

to be located in the first available frequency-domain resource, so as to achieve a possibility of limiting a range of frequency-domain resources for PUSCH frequency hopping and a possibility of PUSCH transmission by using PUSCH frequency hopping.

In some possible embodiments,

$${RB}_{offset}^{1}$$

may be determined according to

$${N}_{available}^{size} .$$

It can be seen that in embodiments of the present disclosure,

$${RB}_{offset}^{1}$$

can be determined according to

$${N}_{available}^{size} ,$$

to make

$${RB}_{offset}^{1} in {N}_{available}^{size} .$$

In this way, after

$${RB}_{offset}^{1}$$

is added, it is beneficial to make

$${RB}_{start}^{2}$$

locate in the first available frequency-domain resource, so as to achieve the possibility of limiting the range of frequency-domain resources for PUSCH frequency hopping, and implement PUSCH frequency hopping on multiple frequency-domain resources in one time-unit, so as to ensure the possibility of PUSCH transmission.

In a specific embodiment,

$${RB}_{offset}^{1}$$

### may be one Mth of

$${N}_{available}^{size} ,$$

where M is a rational number.

It may be noted that if M is a positive rational number, it indicates that the frequency-domain starting position of the first PUSCH resource is smaller than the frequency-domain starting position of the second PUSCH resource, as illustrated in FIG. 5; and if M is a negative rational number, it indicates that the frequency-domain starting position of the first PUSCH resource is greater than that of the second PUSCH resource, as illustrated in FIG. 6.

For example, taking M being a positive integer as an example,

$${RB}_{offset}^{1}$$

may be one half of

$${N}_{available}^{size} ( i . e . ⌊ {N}_{available}^{size} / 2 ⌋ ) ,$$

one quarter of

$${N}_{available}^{size} ( i . e . ⌊ {N}_{available}^{size} / 4 ⌋ ) ,$$

one eighth of

$${N}_{available}^{size} ( i . e . ⌊ {N}_{available}^{size} / 8 ⌋ ) ,$$

or the like.

For another example, taking M being a negative integer as an example, M may be a negative one half of

$${N}_{available}^{size} ( i . e . - ⌊ {N}_{available}^{size} / 2 ⌋ ) ,$$

negative one quarter of

$${N}_{available}^{size} ( i . e . - ⌊ {N}_{available}^{size} / 4 ⌋ ) ,$$

negative one eighth of

$${N}_{available}^{size} ( i . e . - ⌊ {N}_{available}^{size} / 8 ⌋ ) ,$$

or the like.

In some possible embodiments,

$${RB}_{offset}^{1}$$

may be configured through network configuration, pre-configuration, or protocol specification.

It can be noted that, in combination with the content in the foregoing “Frequency Offset between Two Hops”, in the case where

$${RB}_{offset}^{1}$$

is configured through network configuration, for dynamically scheduled PUSCH of frequency-domain resource allocation type 1, the FDRA field of DCI scheduling the PUSCH has N_{UL_hop} bits, and the N_{UL_hop} bits indicate one

$${RB}_{offset}^{1}$$

from multiple candidate

$${RB}_{offset}^{1}$$

configured by higher-layer information. For example, one

$$R {B}_{offset}^{1}$$

is indicated from

$$⌊ {N}_{a v a i l a b l e}^{s i z e} / 2 ⌋ , ⌊ {N}_{a v a i l a b l e}^{s i z e} / 4 ⌋ , and ⌊ {N}_{a v a i l a b l e}^{s i z e} / 8 ⌋$$

### by DCI.

In some possible embodiments, the number of candidate frequency offsets (e. g., candidate

$$R {B}_{offset}^{1} )$$

configured by higher-layer information may be determined by a size relationship between the size of the first available frequency-domain resource and the total size of the multiple frequency-domain resources in one time-unit.

For example, if

$${N}_{a v a i l a b l e}^{s i z e} < {N}_{a l l}^{s i z e} / K , {N}_{UL \_ hop} = 1 ,$$

and 1 or 2 candidate

$$R {B}_{offset}^{1}$$

is configured through a higher-layer parameter (for example, frequency HoppingOffsetLists); and if

$${N}_{a v a i l a b l e}^{s i z e} > {N}_{a l l}^{s i z e} / K , {N}_{UL \_ hop} = 2 , 2$$

or 4 candidate

$$R {B}_{offset}^{1}$$

is configured through a higher-layer parameter (for example, frequency HoppingOffsetLists).

$${N}_{a l l}^{s i z e}$$

represents the total size of multiple frequency-domain resources in one time-unit; K is an integer greater than 1, for example, K can be 2, 3, 4 or 8, etc.

As another example, Table 1 gives candidate

$$R {B}_{offset}^{1} .$$

For another example, if

$${N}_{B W P}^{s i z e} < 50 , {N}_{UL \_ hop} = 1 ,$$

and 1 or 2 candidate

$$R {B}_{offset}^{1}$$

can also be obtained from table 1; and if

$${N}_{B W P}^{s i z e} \leq 50 , {N}_{UL \_ hop} = 2 ,$$

and 2 or 4 candidate

$$R {B}_{offset}^{1}$$

can also be obtained from table 1.

$${N}_{B W P}^{s i z e}$$

represents the size of initial UL BWP.

For PUSCH of CG type 2, the FDRA filed of the DCI activating the PUSCH has N_{UL_hop} bits, which indicate one

$$R {B}_{offset}^{1}$$

among multiple candidate

$${RB}_{offset}^{1}$$

configured by higher-layer information.

For PUSCH of CG 1, one

$${RB}_{offset}^{1}$$

is indicated by higher-layer information. For example, one

$${RB}_{offset}^{1}$$

is indicated by RRC signaling from

$$⌊ {N}_{available}^{size} / 2 ⌋ , ⌊ {N}_{available}^{size} / 4 ⌋ , and ⌊ {N}_{available}^{size} / 8 ⌋ .$$

For PUSCH scheduled by RAR UL grant or PUSCH scheduled by DCI 0-0 scrambled by the TC-RNTI, one

$${RB}_{offset}^{1}$$

is indicated by N_{UL_hop} bits in the DCI.

In summary,

$${RB}_{offset}^{1}$$

can be indicated by higher-layer information or DCI.

TABLE 1

| ${N}_{a v a i l a b l e}^{s i z e}$ | Value of N_{UL}_hop bits | $candidate {RB}_{offset}^{1}$ |
|---|---|---|
| ${N}_{a v a i l a b l e}^{s i z e} < {N}_{a l l}^{s i z e} / K$ | 0 | $⌊ {N}_{a v a i l a b l e}^{s i z e} / 2 ⌋$ |
| | 1 | $⌊ {N}_{a v a i l a b l e}^{s i z e} / 4 ⌋$ |
| ${N}_{a v a i l a b l e}^{s i z e} \geq {N}_{a l l}^{s i z e} / K$ | 00 | $⌊ {N}_{a v a i l a b l e}^{s i z e} / 2 ⌋$ |
| | 01 | $⌊ {N}_{a v a i l a b l e}^{s i z e} / 4 ⌋$ |
| | 10 | $- ⌊ {N}_{a v a i l a b l e}^{s i z e} / 4 ⌋$ |
| | 11 | Reserved |

### Case 2

### a) How to Determine Frequency-Domain Starting Position of Second PUSCH Resource

In “Case 2”, the network device configures multiple available frequency-domain resources for the terminal device, and in this case, a frequency-domain starting position of a first PUSCH resource is located in a second available frequency-domain resource, and a frequency-domain starting position of a second PUSCH resource is located in a third available frequency-domain resource. The frequency-domain starting position of the second PUSCH resource may be determined by network configuration information, preconfigured information, information specified by a protocol, or autonomously by the terminal device.

In a specific embodiment, the frequency-domain starting position of the second PUSCH resource can be autonomously determined by the terminal device; or the frequency-domain starting position of the second PUSCH resource may be determined by at least one of a frequency-domain starting position of the first PUSCH resource, a frequency-domain starting position of the second available frequency-domain resource, a frequency offset, a frequency-domain starting position of the third available frequency-domain resource, and the size of the third available frequency-domain resource.

It can be understood that the terminal device may autonomously determine the frequency-domain starting position of the second PUSCH resource, or the terminal device may determine the frequency-domain starting position of the second PUSCH resource according to at least one of the frequency-domain starting position of the first PUSCH resource, the frequency-domain starting position of the second available frequency-domain resource, the frequency offset, the frequency-domain starting position of the third available frequency-domain resource, or the size of the third available frequency-domain resource.

In addition, since PUSCH frequency hopping in embodiments of the present disclosure may be intra-slot frequency hopping, or inter-slot frequency hopping, how to determine the frequency-domain starting position of the second PUSCH resource according to the above information will be illustrated below respectively in the case of intra-slot frequency hopping and the case of inter-slot frequency hopping.

### Example 1

For intra-slot frequency hopping, the frequency-domain starting position of the second PUSCH resource may be expressed as:

$${RB}_{start}^{2} = ( {RB}_{start}^{1} - {N}_{available , 1}^{start} + {RB}_{offset}^{2} ) mod ( \vert {N}_{available , 2}^{start} + {N}_{available , 2}^{size} - {N}_{available , 1}^{start} \vert ) .$$

$${RB}_{start}^{2}$$

represents a frequency-domain starting position of a second PUSCH resource,

$${RB}_{start}^{2}$$

represents a frequency-domain starting position of a first PUSCH resource,

$${N}_{available , 1}^{start}$$

represents a frequency-domain starting position of a second available frequency-domain resource,

$${RB}_{offset}^{2}$$

represents a frequency offset,

$${N}_{available , 2}^{start}$$

represents a frequency-domain starting position of a third available frequency-domain resource, and

$${N}_{available , 2}^{size}$$

represents the size of the third available frequency-domain resource. In this embodiment,

$${RB}_{start}^{2}$$

is the frequency-domain starting position of the second PUSCH resource with reference to the frequency-domain starting position of the second available frequency-domain resource.

For intra-slot frequency hopping, the frequency-domain starting position of the second PUSCH resource may be expressed as:

$${RB}_{start}^{2} = {N}_{available , 1}^{start} + ( {RB}_{start}^{1} - {N}_{available , 1}^{start} + {RB}_{offset}^{2} ) mod ( \vert {N}_{available , 2}^{start} + {N}_{available , 2}^{size} - {N}_{available , 1}^{start} \vert ) .$$

$${RB}_{start}^{2}$$

represents a frequency-domain starting position of a second PUSCH resource,

$${RB}_{start}^{2}$$

represents a frequency-domain starting position of a first PUSCH resource,

$${N}_{available , 1}^{start}$$

represents a frequency-domain starting position of a second available frequency-domain resource,

$${RB}_{offset}^{2}$$

represents a frequency offset,

$${N}_{available , 2}^{start}$$

represents a frequency-domain starting position of a third available frequency-domain resource, and

$${N}_{available , 2}^{size}$$

represents the size of the third available frequency-domain resource. In this embodiment,

$${RB}_{start}^{2}$$

is the frequency-domain starting position of the second PUSCH resource with reference to the start of UL active BWP.

Taking FIG. 7 as an example, a time unit is a slot,

$${RB}_{start}^{2}$$

represents the frequency-domain starting position of PUSCH resource 760,

$${RB}_{start}^{1}$$

represents the frequency-domain starting position of PUSCH resource 750,

$${N}_{available , 1}^{start}$$

represents the frequency-domain starting position of uplink frequency-domain resource 720,

$${RB}_{offset}^{2}$$

represents an interval between the frequency-domain starting position of PUSCH resource 750 and the frequency-domain starting position of PUSCH resource 760,

$${N}_{available , 2}^{start}$$

represents the frequency-domain starting position of uplink frequency-domain resource 740, and

$${N}_{available , 2}^{size}$$

represents the size of uplink frequency-domain resource 740.

It can be noted that, since Point A is used as a reference point for both

$${RB}_{start}^{1} and {N}_{uplink , 1}^{start} ,$$

the reference point may be changed from Point A to Point

$${N}_{available , 1}^{start}$$

through

$${RB}_{start}^{1} - {N}_{available , 1}^{start} ,$$

and then

$${N}_{available , 1}^{start}$$

is used as a reference point and added with

$${RB}_{offset}^{2} ,$$

and a modulo operation is performed on the sum with

$$\vert {N}_{available , 2}^{start} + {N}_{available , 2}^{size} - {N}_{available , 1}^{start} \vert ,$$

so that

$${RB}_{start}^{2}$$

is obtained through calculation, and

$${RB}_{start}^{2}$$

is located in the third available frequency-domain resource, so that the possibility of limiting the range of frequency-domain resources for PUSCH frequency hopping may be implemented, and PUSCH frequency hopping may be implemented on multiple frequency-domain resources in one time-unit, so as to ensure the possibility of PUSCH transmission. In other embodiments, the start of UL active BWP can also be used as a reference point for both

$$R {B}_{start}^{1} and {N}_{uplink , 1}^{start} ,$$

the reference point may be changed from the start of UL active BWP to Point

$${N}_{available , 1}^{start}$$

through

$${RB}_{start}^{1} - {N}_{available , 1}^{start} ,$$

and then

$${N}_{available , 1}^{start}$$

is used as a reference point and added with

$${RB}_{offset}^{2} ,$$

and a modulo operation is performed on the sum with

$$\vert {N}_{available , 2}^{start} + {N}_{available , 2}^{size} - {N}_{available , 1}^{start} \vert ,$$

so that

$${RB}_{start}^{2}$$

is obtained through calculation, and

$${RB}_{start}^{2}$$

is located in the third available frequency-domain resource, so that the possibility of limiting the range of frequency-domain resources for PUSCH frequency hopping may be implemented, and PUSCH frequency hopping may be implemented on multiple frequency-domain resources in one time-unit, so as to ensure the possibility of PUSCH transmission.

### Example 2

For inter-slot frequency hopping, the frequency-domain starting position of the second PUSCH resource may be expressed as

$${RB}_{start}^{2} ( {n}_{s}^{μ} ) = ( {RB}_{start}^{1} - {N}_{available , 1}^{start} + {RB}_{offset}^{2} ) mod ( \vert {N}_{available , 2}^{start} + {N}_{available , 2}^{size} - {N}_{available , 1}^{start} \vert ) \cdot {n}_{s}^{μ} mod 2 = 0$$

$$or$$

$${n}_{s}^{μ} mod 2 = 1 , {RB}_{start}^{2} ( {n}_{s}^{μ} )$$

represents a frequency-domain starting position of a second PUSCH resource in

$$slot {n}_{s}^{μ} , {RB}_{start}^{1}$$

represents a frequency-domain starting position of a first PUSCH resource,

$${N}_{available , 1}^{start}$$

represents a frequency-domain starting position of a second available frequency-domain resource,

$${RB}_{offset}^{2}$$

represents a frequency offset,

$${N}_{available , 2}^{start}$$

represents a frequency-domain starting position of a third available frequency-domain resource, and

$${N}_{available , 2}^{size}$$

represents the size of the third available frequency-domain resource. In this embodiment,

$${RB}_{start}^{2} ( {n}_{s}^{μ} )$$

is the frequency-domain starting position of the second PUSCH resource with reference to the frequency-domain starting position of the second available frequency-domain resource.

In another possible embodiment, for inter-slot frequency hopping, the frequency-domain starting position of the second PUSCH resource may be expressed as

$${RB}_{start}^{2} ( {n}_{s}^{μ} ) = {N}_{available , 1}^{start} + ( {RB}_{start}^{1} - {N}_{available , 1}^{start} + {RB}_{offset}^{2} ) mod ( \vert {N}_{available , 2}^{start} + {N}_{available , 2}^{size} - {N}_{available , 1}^{start} \vert ) \cdot {n}_{s}^{μ} mod 2 = 0 or {n}_{s}^{μ} mod 2 = 1 , {RB}_{start}^{2} ( {n}_{s}^{μ} )$$

represents a frequency-domain starting position of a second PUSCH resource in

$${slotn}_{s}^{μ} , {RB}_{start}^{1}$$

represents a frequency-domain starting position of a first PUSCH resource,

$${N}_{available , 1}^{start}$$

represents a frequency-domain starting position of a second available frequency-domain resource,

$${RB}_{offset}^{2}$$

represents a frequency offset,

$${N}_{available , 2}^{start}$$

represents a frequency-domain starting position of a third available frequency-domain resource, and

$${N}_{available , 2}^{size}$$

represents the size of the third available frequency-domain resource. In this embodiment,

$${RB}_{start}^{2} ( {n}_{s}^{μ} )$$

is the frequency-domain starting position of the second PUSCH resource with reference to the start of UL active BWP.

$${RB}_{offset}^{2} \qquad b )$$

In some possible embodiments,

$${RB}_{offset}^{2}$$

may range from

$$( \vert {N}_{available , 2}^{start} - {N}_{available , 1}^{start} \vert ) to ( \vert {N}_{available , 2}^{start} + {N}_{available , 2}^{size} - {N}_{available , 1}^{start} \vert - 1 ) .$$

It can be noted that by limiting

$${RB}_{offset}^{2}$$

ranging from

$$( \vert {N}_{available , 2}^{start} - {N}_{available , 1}^{start} \vert ) to ( \vert {N}_{available , 2}^{start} + {N}_{available , 2}^{size} - {N}_{available , 1}^{start} \vert - 1 ) , {RB}_{offset}^{2}$$

falls between

$$( \vert {N}_{available , 2}^{start} - {N}_{available , 1}^{start} \vert ) and ( \vert {N}_{available , 2}^{start} + {N}_{available , 2}^{size} - {N}_{available , 1}^{start} \vert - 1 ) .$$

In this way, after

$${RB}_{offset}^{2}$$

is added, it is beneficial to enable

$${RB}_{start}^{2}$$

to be located in the third available frequency-domain resource, so as to achieve the possibility of limiting the range of frequency-domain resources for PUSCH frequency hopping, and implement PUSCH frequency hopping on multiple frequency-domain resources in one time-unit, so as to ensure the possibility of PUSCH transmission.

In some possible embodiments,

$${RB}_{offset}^{2}$$

may be determined according to

$$\vert {N}_{available , 2}^{start} + {N}_{available , 2}^{size} - {N}_{available , 1}^{start} \vert .$$

In a specific embodiment,

$${RB}_{offset}^{2}$$

may be equal to

$$\vert {N}_{available , 2}^{start} + {N}_{available , 2}^{size} - {N}_{available , 1}^{start} \vert / N ,$$

where N is a rational number, and

$$\vert {N}_{available , 2}^{start} + {N}_{available , 2}^{size} - {N}_{available , 1}^{start} \vert / N$$

is greater than

$$( \vert {N}_{available , 2}^{start} - {N}_{available , 1}^{start} \vert ) .$$

It should be noted that if N is a positive rational number, it indicates that the frequency-domain starting position of the first PUSCH resource is smaller than the frequency-domain starting position of the second PUSCH resource, as illustrated in FIG. 7; and if N is a negative rational number, it indicates that the frequency-domain starting position of the first PUSCH resource is greater than the frequency-domain starting position of the second PUSCH resource, as illustrated in FIG. 8.

For example, taking N being a positive integer as an example,

$${RB}_{offset}^{2}$$

may be one half of

$$\vert {N}_{available , 2}^{start} + {N}_{available , 2}^{size} - {N}_{available , 1}^{start} \vert$$

(i.e.

$$⌊ \vert {N}_{available , 2}^{start} + {N}_{available , 2}^{size} - {N}_{available , 1}^{start} \vert / 2 ⌋ ) , one quarter of \vert {N}_{available , 2}^{start} + {N}_{available , 2}^{size} - {N}_{available , 1}^{start} \vert ( i . e . ⌊ \vert {N}_{available , 2}^{start} + {N}_{available , 2}^{size} - {N}_{available , 1}^{start} \vert / 4 ⌋ ) ,$$

$$\vert {N}_{available , 2}^{start} + {N}_{available , 2}^{size} - {N}_{available , 1}^{start} \vert ( i . e . ⌊ \vert {N}_{available , 2}^{start} + {N}_{available , 2}^{size} - {N}_{available , 1}^{start} \vert / 8 ⌋ ) ,$$

or the like.

For another example, taking N being a negative integer as an example,

$${RB}_{offset}^{2}$$

may be negative one half of

$$\vert {N}_{available , 2}^{start} + {N}_{available , 2}^{size} - {N}_{available , 1}^{start} \vert ( i . e . - ⌊ \vert {N}_{available , 2}^{start} + {N}_{available , 2}^{s i z e} - {N}_{available , 1}^{start} \vert / 2 ⌋ ) ,$$

negative one quarter of

$$\vert {N}_{available , 2}^{start} + {N}_{available , 2}^{s i z e} - {N}_{available , 1}^{start} \vert ( i . e . - ⌊ \vert {N}_{available , 2}^{start} + {N}_{available , 2}^{size} - {N}_{available , 1}^{start} \vert / 4 ⌋ ) ,$$

negative one eighth of

$$\vert {N}_{available , 2}^{start} + {N}_{available , 2}^{size} - {N}_{available , 1}^{start} \vert ( i . e . - ⌊ \vert {N}_{available , 2}^{start} + {N}_{available , 2}^{size} - {N}_{available , 1}^{start} \vert / 8 ⌋ ) ,$$

or the like.

In some possible embodiments,

$${RB}_{offset}^{2}$$

may be configured through network configuration, pre-configuration, or protocol specification.

It can be noted that, in combination with the content in the foregoing “Frequency Offset between Two Hops”, in the case where

$${RB}_{offset}^{2}$$

is configured through network configuration, for dynamically scheduled PUSCH of frequency-domain resource allocation type 1, the FDRA field of DCI scheduling the PUSCH has N_{UL_hop} bits, and the N_{UL_hop} bits indicate one

$${RB}_{offset}^{2}$$

from multiple candidate

$${RB}_{offset}^{2}$$

configured by higher-layer information. For example, one

$${RB}_{offset}^{2}$$

is indicated from

$$⌊ \vert {N}_{available , 2}^{start} + {N}_{available , 2}^{size} - {N}_{available , 1}^{start} \vert / 2 ⌋ , ⌊ \vert {N}_{available , 2}^{start} + {N}_{available , 2}^{size} - {N}_{available , 1}^{start} \vert / 4 ⌋ , and ⌊ \vert {N}_{available , 2}^{start} + {N}_{available , 2}^{size} - {N}_{available , 1}^{start} \vert / 8 ⌋$$

### by DCI.

For PUSCH of CG type 2, the FDRA filed of the DCI activating the PUSCH has N_{UL_hop} bits, which indicate one

$${RB}_{offset}^{2}$$

among multiple candidate

$${RB}_{offset}^{2}$$

configured by higher-layer information.

For PUSCH of CG 1, one

$${RB}_{offset}^{2}$$

is indicated by higher-layer information. For example, one

$${RB}_{offset}^{2}$$

is indicated by RRC signaling from

$$⌊ \vert {N}_{available , 2}^{start} + {N}_{available , 2}^{size} - {N}_{available , 1}^{start} \vert / 2 ⌋ , ⌊ \vert {N}_{available , 2}^{start} + {N}_{available , 2}^{size} - {N}_{available , 1}^{start} \vert / 4 ⌋ , and ⌊ \vert {N}_{available , 2}^{start} + {N}_{available , 2}^{size} - {N}_{available , 1}^{start} \vert / 8 ⌋ .$$

For PUSCH scheduled by RAR UL grant or PUSCH scheduled by DCI 0-0 scrambled by the TC-RNTI, one

$${RB}_{offset}^{2}$$

is indicated by N_{UL_hop} bits in the DCI.

In summary,

$${RB}_{offset}^{2}$$

can be indicated by higher-layer information or DCI.

### VI. Exemplary Description of Communication Method

With reference to the foregoing content, the following describes, by using an example of interaction between a network device and a terminal device, a communication method provided in an embodiment of the present invention. It should be noted that the network device may be a chip, a chip module, or a communication module, and the terminal device may be a chip, a chip module, or a communication module. In other words, the method is applied to a network device or a terminal device, which is not specifically limited.

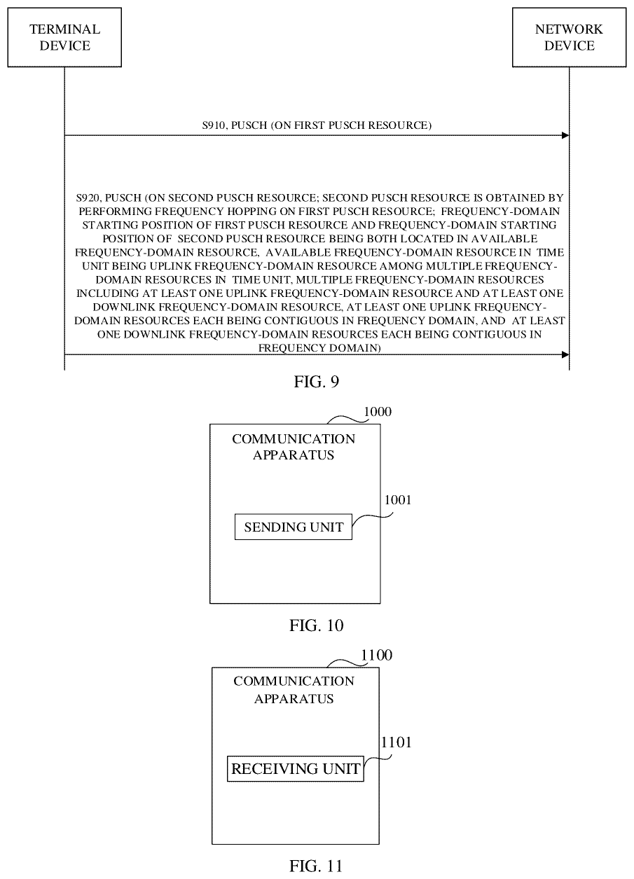

FIG. 9 is a schematic flowchart of a communication method provided in an embodiment of the present disclosure. The communication method specifically includes the following operations.

At S910, the terminal device sends PUSCH on a first PUSCH resource.

Correspondingly, the network device receives the PUSCH on the first PUSCH resource.

At S920, the terminal device sends the PUSCH on a second PUSCH resource, where the second PUSCH resource is obtained by performing frequency hopping on the first PUSCH resource. A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

Correspondingly, the network device receives the PUSCH on the second PUSCH resource.

The frequency-domain starting position of the first PUSCH resource and the frequency-domain starting position of the second PUSCH resource being both located in an available frequency-domain resource may refer to that the frequency-domain starting position of the first PUSCH resource is located in an available frequency-domain resource, and the frequency-domain starting position of the second PUSCH resource is also located in an available frequency-domain resource, and the two available frequency-domain resources may be the same or different, which is not limited in the present disclosure.

It should be noted that, for “first PUSCH resource”, “second PUSCH resource”, “frequency-domain starting position of the first PUSCH resource”, “frequency-domain starting position of the second PUSCH resource”, “multiple frequency-domain resources”, and “time unit”, and the like, reference may be made to the content in the foregoing “V. Limiting Range of Frequency-Domain Resources for PUSCH Frequency Hopping”, and other relevant content, which will not be repeated herein.

In embodiments of the present disclosure, a new frequency-domain resource allocation method is introduced, that is, multiple frequency-domain resources are allocated to one-time unit, and the multiple frequency-domain resources include at least one uplink frequency-domain resource and at least one downlink frequency-domain resource. In order to avoid that the second PUSCH resource may go beyond available frequency-domain resources (an available frequency-domain resource being an uplink frequency-domain resource among the multiple frequency-domain resources), to be located in unavailable frequency-domain resources (the unavailable frequency-domain resources being downlink frequency-domain resources among the multiple frequency-domain resources and uplink frequency-domain resources allocated to other terminal devices), which may result in that the terminal device is unable to send PUSCH on the first PUSCH resource and/or the second PUSCH resource, that is, the terminal device is unable to send PUSCH through PUSCH frequency hopping, in embodiments of the present disclosure, both the frequency-domain starting position of the first PUSCH resource and the frequency-domain starting position of the second PUSCH resource are located in an available frequency-domain resource. Since the frequency-domain starting position of the second PUSCH resource is located in an available frequency-domain resource, that is, the range of frequency-domain resources for PUSCH frequency hopping in the multiple frequency-domain resources is limited, the second PUSCH resource may be used normally for communication, thereby solving the problem of how to perform PUSCH frequency hopping under the new frequency-domain resource allocation, and ensuring the PUSCH transmission.

In some possible embodiments, the frequency-domain starting position of the first PUSCH resource and the frequency-domain starting position of the second PUSCH resource are located in the same or different available frequency-domain resources.

It should be noted that, in combination with the content in the above “(6) Frequency-Domain Starting Position of First PUSCH Resource and Frequency-Domain Starting Position of Second PUSCH Resource (i.e. Frequency-Domain Starting Position of Each of Two Hops of PUSCH Frequency Hopping) Being Located in Same Available Frequency-Domain Resource”, in embodiments of the present disclosure, whether the frequency-domain starting position of the first PUSCH resource and the frequency-domain starting position of the second PUSCH resource are located in the same available frequency-domain resource can be configured flexibly according to different scenario requirements and different terminal device capabilities, to avoid a second hop of PUSCH in multiple frequency-domain resources in one time-unit from going beyond available frequency-domain resources, to enable the possibility of the range of frequency-domain resources for PUSCH frequency hopping.

In some possible embodiments, both the frequency-domain starting position of the first PUSCH resource and the frequency-domain starting position of the second PUSCH resource are located in the first available frequency-domain resource.

The first available frequency-domain resource is an available frequency-domain resource.

It should be noted that, in combination with the content in the above “(6) Frequency-Domain Starting Position of First PUSCH Resource and Frequency-Domain Starting Position of Second PUSCH Resource (i.e. Frequency-Domain Starting Position of Each of Two Hops of PUSCH Frequency Hopping) Being Located in Same Available Frequency-Domain Resource”, in embodiments of the present disclosure, the frequency-domain starting position of the first PUSCH resource and the frequency-domain starting position of the second PUSCH resource may be located in the same available frequency-domain resource, so that a specific scenario requirement or a capability of a terminal device can be met, and a possibility of limiting the range of frequency-domain resources for PUSCH frequency hopping may be achieved.

In some possible embodiments, the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource. The frequency offset is an interval between the frequency-domain starting position of the first PUSCH resource in the first available frequency-domain resource and the frequency-domain starting position of the second PUSCH resource in the first available frequency-domain resource.

It should be noted that, in combination with the content in the above “(10) How to Determine Frequency-Domain Starting Position of Second PUSCH Resource”, the terminal device may determine the frequency-domain starting position of the second PUSCH resource according to at least one of: the frequency-domain starting position of the first PUSCH resource, a frequency-domain starting position of the first available frequency-domain resource, a frequency offset, or a size of the first available frequency-domain resource, thereby realizing the possibility of limiting the range of frequency-domain resources for PUSCH frequency hopping, and to achieve the possibility of PUSCH transmission by using PUSCH frequency hopping.

In some possible embodiments, the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource includes calculating the frequency-domain starting position of the second PUSCH resource as follows. subtract the frequency-domain starting position of the first available frequency-domain resource from the frequency-domain starting position of the first PUSCH resource to obtain a first calculation result; add the frequency offset to the first calculation result to obtain a second calculation result; and perform a modulo operation on the second calculation result and the size of the first available frequency-domain resource.

In other words, the frequency-domain starting position of the second PUSCH resource may be expressed as:

$${RB}_{start}^{2} = ( {RB}_{start}^{1} - {N}_{available}^{start} + {RB}_{offset}^{1} ) mod {N}_{available}^{size}$$

with reference to the frequency-domain starting position of a first available frequency-domain resource; or

$${RB}_{start}^{2} = {N}_{available}^{start} + ( {RB}_{start}^{1} - {N}_{available}^{start} + {RB}_{offset}^{1} ) mod {N}_{available}^{size} ,$$

with reference to the start of UL active BWP.

$${RB}_{start}^{2}$$

represents a frequency-domain starting position of a second PUSCH resource,

$${RB}_{start}^{1}$$

represents a frequency-domain starting position of a first PUSCH resource,

$${N}_{available}^{start}$$

represents a frequency-domain starting position of a first available frequency-domain resource,

$${RB}_{offset}^{1}$$

represents a frequency offset,

$${N}_{available}^{size}$$

represents the size of the first available frequency-domain resource, and mod represents an modulo operation.

It should be noted that, in combination with the content in the above “(10) How to Determine Frequency-Domain Starting Position of Second PUSCH Resource”, since Point A (or the start of UL active BWP) is used as a reference point for both

$$R {B}_{start}^{1} and {N}_{available}^{start} ,$$

the reference point may be changed from Point A (or the start of UL active BWP) to

$${N}_{available}^{start}$$

through

$${RB}_{start}^{1} - {N}_{uplink}^{start} , and then {N}_{available}^{start}$$

is used as a reference point and added with

$${RB}_{offset}^{1} ,$$

and a modulo operation is performed on the sum with

$${N}_{available}^{size} ,$$

so that

$${RB}_{start}^{2}$$

may be obtained through calculation, and

$${RB}_{start}^{2}$$

may be located in the first available frequency-domain resource, the possibility of limiting the range of frequency-domain resources for PUSCH frequency hopping may be achieved, and the possibility of PUSCH transmission using PUSCH frequency hopping may be achieved.

In some possible embodiments, the frequency offset ranges from 1 to the size of the first available frequency-domain resource minus 1.

It should be noted that, in combination with the content in the above “(10) How to Determine Frequency-Domain Starting Position of Second PUSCH Resource”, by limiting the frequency offset ranging from 1 to the size of the first available frequency-domain resource minus 1, the frequency offset may be enabled to be in the size of the first available frequency-domain resource. In this way, after the frequency offset is added, it is beneficial to enable the frequency-domain starting position of the second PUSCH resource to be located in the first available frequency-domain resource, so that the possibility of limiting the range of frequency-domain resources for PUSCH frequency hopping is realized, and the possibility of PUSCH transmission using PUSCH frequency hopping may be achieved.

In some possible embodiments, the frequency offset may be determined according to the size of the first available frequency-domain resource.

It should be noted that, in combination with the content of “(10) How to Determine Frequency-Domain Starting Position of Second PUSCH Resource”, in embodiments of the present disclosure, the frequency offset may be determined according to the size of the first available frequency-domain resource, so that the frequency offset is in the size of the first available frequency-domain resource. In this way, after the frequency offset is added, the frequency-domain starting position of the second PUSCH resource may be located in the first available frequency-domain resource, thereby limiting the range of frequency-domain resources for PUSCH frequency hopping.

Exemplarily, the frequency offset is determined according to the size of the first available frequency-domain resource includes the frequency offset being one of the following: one half of the size of the first available frequency-domain resource, one quarter of the size of the first available frequency-domain resource, and one eighth of the size of the first available frequency-domain resource.

It should be noted that, in combination with the content in the above “(10) How to Determine Frequency-Domain Starting Position of Second PUSCH Resource”, in embodiments of the present disclosure, the frequency offset may be directly determined/configured/indicated as one half, one quarter, or one eighth of the size of the first available frequency-domain resource. In this way, the frequency offset is determined according to the size of the first available frequency-domain resource, so that the frequency offset is in the size of the first available frequency-domain resource. In this way, after the frequency offset is added, the frequency-domain starting position of the second PUSCH resource may be located in the first available frequency-domain resource, thereby limiting the range of frequency-domain resources for PUSCH frequency hopping.

In some possible embodiments, the frequency offset may be indicated by higher-layer information or DCI.

It should be noted that, in combination with the content of “(10) How to Determine Frequency-Domain Starting Position of Second PUSCH Resource”, in embodiments of the present disclosure, the frequency offset may be indicated by higher-layer information or DCI, so that the network configures the frequency offset.

In some possible embodiments, the frequency-domain starting position of the first PUSCH resource is in a second available frequency-domain resource, and the frequency-domain starting position of the second PUSCH resource is in a third available frequency-domain resource. The second available frequency-domain resource and the third available frequency-domain resource are two different available frequency-domain resources.

It should be noted that, in combination with the content in the above “(8) Frequency-Domain Starting Position of First PUSCH Resource and Frequency-Domain Starting Position of Second PUSCH Resource (i.e. Frequency-Domain Starting Position of Each of Two Hops of PUSCH Frequency Hopping) Being Located in Different Available Frequency-Domain Resources”, in embodiments of the present disclosure, the frequency-domain starting position of the first PUSCH resource and the frequency-domain starting position of the second PUSCH resource may be enabled to be located in different available frequency-domain resources. In this way, a possibility of limiting the range of frequency-domain resources for PUSCH frequency hopping may be achieved to meet a specific scenario requirement or a capability of the terminal device.

In some possible embodiments, the third available frequency-domain resource has a largest size among the multiple available frequency-domain resources except the second available frequency-domain resource.

It should be noted that, in combination with the content in “(9) Second Available Frequency-Domain Resource and Third Available Frequency-Domain Resource”, since the third available frequency-domain resource has a largest size among the multiple available frequency-domain resources except the second available frequency-domain resource, it can be ensured that the frequency-domain starting position of the second PUSCH resource (i. e. the second hop of the PUSCH frequency hopping) is in a larger uplink frequency-domain resource, which helps to prevent the frequency-domain resource range of the second PUSCH resource from exceeding the larger uplink frequency-domain resource as far as possible.

### VII. Exemplary Description of Communication Apparatus

The foregoing solutions of embodiments of the disclosure are mainly described from the viewpoint of the method side. It can be understood that, in order to implement the above functions, the terminal or the network device includes hardware structures and/or software modules for performing the respective functions. Those skilled in the art may readily recognize that, in combination with the units and algorithmic operations of various examples described in the embodiments disclosed herein, the disclosure can be implemented in hardware or a combination of the hardware and computer software. Whether a function is implemented by way of the hardware or hardware driven by the computer software depends on the particular application and design constraints of the technical solution. Those skilled in the art may use different methods to implement the described functions for each particular application, but such implementation may not be considered as beyond the scope of the disclosure.

According to embodiments of the disclosure, functional units may be divided for the terminal or the network device in accordance with the foregoing method examples. For example, each functional unit may be divided according to each function, and two or more functions may be integrated in one processing unit. The above-mentioned integrated unit can be implemented in the form of hardware or software program modules. It should be noted that the division of units in embodiments of the disclosure is schematic, and is merely a logical function division, and there may be other division manners in actual implementation.

In the case of the integrated unit, FIG. 10 is a block diagram illustrating functional units of a communication apparatus provided in an embodiment of the disclosure. The communication apparatus 1000 includes a sending unit 1001.

It may be noted that the sending unit 1001 may be a module unit configured to deal with a signal, data, information, etc., which is not specifically limited herein.

The communication apparatus 1000 may further include a storage unit. The storage unit is configured to store computer program codes or instructions executed by the communication apparatus 1000. The storage unit may be a memory.

In addition, it may be noted that the communication apparatus 1000 may be a chip or a chip module.

The sending unit 1001 may be integrated into another unit. For example, the sending unit 1001 may be integrated into a communication unit. The communication unit may be a communication interface, a transceiver, a transceiver circuit, etc. For another example, the sending unit 1001 may be integrated into a processing unit. The processing unit may be a processor or a controller, for example, a baseband processor, a baseband chip, a central processing unit (CPU), a general-purpose processor, a digital signal processor (DSP), an application-specific integrated circuit (ASIC), a field programmable gate array (FPGA), or other programmable logic devices, transistor logic devices, hardware components, or a combination thereof. Various exemplary logic blocks, modules, and circuits disclosed in the disclosure can be implemented or executed by the processing unit. The processing unit may also be a combination for implementing computing functions, for example, one or more microprocessors, a combination of DSP and microprocessor, or the like.

In specific implementation, the sending unit 1001 is configured to perform any one operation performed by a terminal device/chip/module in the above method embodiments, for example, sending data or receiving data. The following provides detailed description.

In specific implementation, the sending unit 1001 is configured to perform any one operation in the above method embodiments, and selectively invoke another unit to complete corresponding operations when performing data transmission such as sending. The following provides detailed description.

The sending unit 1001 is configured to send PUSCH on a first PUSCH resource.

The sending unit 1001 is further configured to send the PUSCH on a second PUSCH resource, where the second PUSCH resource is obtained by performing frequency hopping on the first PUSCH resource.

A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

In embodiments of the present disclosure, a new frequency-domain resource allocation method is introduced, that is, multiple frequency-domain resources are allocated to one-time unit, and the multiple frequency-domain resources include at least one uplink frequency-domain resource and at least one downlink frequency-domain resource. In order to avoid that the second PUSCH resource may go beyond available frequency-domain resources (an available frequency-domain resource being an uplink frequency-domain resource allocated thereto among the multiple frequency-domain resources), to be located in unavailable frequency-domain resources (the unavailable frequency-domain resources being downlink frequency-domain resources among the multiple frequency-domain resources and uplink frequency-domain resources allocated to other terminal devices), which may result in that the terminal device is unable to send PUSCH on the first PUSCH resource and/or the second PUSCH resource, that is, the terminal device is unable to send PUSCH through PUSCH frequency hopping, in embodiments of the present disclosure, both the frequency-domain starting position of the first PUSCH resource and the frequency-domain starting position of the second PUSCH resource are located in an available frequency-domain resource. Since the frequency-domain starting position of the second PUSCH resource is located in an available frequency-domain resource, that is, the range of frequency-domain resources for PUSCH frequency hopping in the multiple frequency-domain resources is limited, the second PUSCH resource may be used normally for communication, thereby solving the problem of how to perform PUSCH frequency hopping under the new frequency-domain resource allocation, and ensuring the PUSCH transmission.

It may be noted that for specific implementation of each operation in the embodiments illustrated in FIG. 10, reference can be made to the description of the method embodiments above, which is not repeated herein.

In some possible embodiments, the frequency-domain starting position of the first PUSCH resource and the frequency-domain starting position of the second PUSCH resource are located in the same or different available frequency-domain resources.

In some possible embodiments, both the frequency-domain starting position of the first PUSCH resource and the frequency-domain starting position of the second PUSCH resource are located in a first available frequency-domain resource.

In some possible embodiments, the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource; and the frequency offset is an interval between the frequency-domain starting position of the first PUSCH resource in the first available frequency-domain resource and the frequency-domain starting position of the second PUSCH resource in the first available frequency-domain resource.

In some possible embodiments, the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource includes calculating the frequency-domain starting position of the second PUSCH resource. The frequency-domain starting position of the second PUSCH resource can be calculates by subtracting the frequency-domain starting position of the first available frequency-domain resource from the frequency-domain starting position of the first PUSCH resource to obtain a first calculation result; adding the frequency offset to the first calculation result to obtain a second calculation result; and performing a modulo operation on the second calculation result and the size of the first available frequency-domain resource.

In some possible embodiments, the frequency offset ranges from 1 to the size of the first available frequency-domain resource minus 1.

In some possible embodiments, the frequency offset is determined according to the size of the first available frequency-domain resource.

In some possible embodiments, the frequency offset being determined according to the size of the first available frequency-domain resource includes: the frequency offset being one of the following: one half of the size of the first available frequency-domain resource, one quarter of the size of the first available frequency-domain resource, and one eighth of the size of the first available frequency-domain resource.

In some possible embodiments, the frequency offset is indicated by higher-layer information or DCI.

In some possible embodiments, the frequency-domain starting position of the first PUSCH resource is located in a second available frequency-domain resource, and the frequency-domain starting position of the second PUSCH resource is located in a third available frequency-domain resource; and the second available frequency-domain resource and the third available frequency-domain resource are different two available frequency-domain resources or the same available frequency-domain resource.

In some possible embodiments, the third available frequency-domain resource has a largest size among the multiple available frequency-domain resources except the second available frequency-domain resource.

### VII. Exemplary Description of Another Communication Apparatus

In the case of the integrated unit, FIG. 11 is a block diagram illustrating functional units of a communication apparatus provided in an embodiment of the disclosure. The communication apparatus 1100 includes a receiving unit 1101.

It may be noted that the receiving unit 1101 may be a module unit configured to deal with a signal, data, information, etc., which is not specifically limited herein.

The communication apparatus 1100 may further include a storage unit. The storage unit is configured to store computer program codes or instructions executed by the communication apparatus 1100. The storage unit may be a memory.

In addition, it may be noted that the communication apparatus 1100 may be a chip or a chip module.

The receiving unit 1101 may be integrated into another unit. For example, the receiving unit 1101 may be integrated into a communication unit. The communication unit may be a communication interface, a transceiver, a transceiver circuit, etc. For another example, the receiving unit 1101 may be integrated into a processing unit. The processing unit may be a processor or a controller, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or a combination thereof. Various exemplary logic blocks, modules, and circuits disclosed in the disclosure can be implemented or executed by the processing unit. The processing unit may also be a combination for implementing computing functions, for example, one or more microprocessors, a combination of DSP and microprocessor, or the like.

In specific implementation, the receiving unit 1101 is configured to perform any one operation performed by a terminal device/chip/module in the above method embodiments, for example, sending data or receiving data. The following provides detailed description.

In specific implementation, the receiving unit 1101 is configured to perform any one operation in the above method embodiments, and selectively invoke another unit to complete corresponding operations when performing data transmission such as sending. The following provides detailed description.

The receiving unit 1101 is configured to receive PUSCH on a first PUSCH resource.

The receiving unit 1101 is further configured to receive the PUSCH on a second PUSCH resource, where the second PUSCH resource is obtained by performing frequency hopping on the first PUSCH resource.

A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

In embodiments of the present disclosure, a new frequency-domain resource allocation method is introduced, that is, multiple frequency-domain resources are allocated to one-time unit, and the multiple frequency-domain resources include at least one uplink frequency-domain resource and at least one downlink frequency-domain resource. In order to avoid that the second PUSCH resource may go beyond available frequency-domain resources (an available frequency-domain resource being an uplink frequency-domain resource allocated thereto among the multiple frequency-domain resources), to be located in unavailable frequency-domain resources (the unavailable frequency-domain resources being downlink frequency-domain resources among the multiple frequency-domain resources and uplink frequency-domain resources allocated to other terminal devices), which may result in that the terminal device is unable to send PUSCH on the first PUSCH resource and/or the second PUSCH resource, that is, the terminal device is unable to send PUSCH through PUSCH frequency hopping, in embodiments of the present disclosure, both the frequency-domain starting position of the first PUSCH resource and the frequency-domain starting position of the second PUSCH resource are located in an available frequency-domain resource. Since the frequency-domain starting position of the second PUSCH resource is located in an available frequency-domain resource, that is, the range of frequency-domain resources for PUSCH frequency hopping in the multiple frequency-domain resources is limited, the second PUSCH resource may be used normally for communication, thereby solving the problem of how to perform PUSCH frequency hopping under the new frequency-domain resource allocation, and ensuring the PUSCH transmission. It may be noted that for specific implementation of each operation in the embodiments illustrated in FIG. 11, reference can be made to the description of the method embodiments above, which is not repeated herein.

In some possible embodiments, the frequency-domain starting position of the first PUSCH resource and the frequency-domain starting position of the second PUSCH resource are located in the same or different available frequency-domain resources.

In some possible embodiments, both the frequency-domain starting position of the first PUSCH resource and the frequency-domain starting position of the second PUSCH resource are located in a first available frequency-domain resource.

In some possible embodiments, the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource; and the frequency offset is an interval between the frequency-domain starting position of the first PUSCH resource in the first available frequency-domain resource and the frequency-domain starting position of the second PUSCH resource in the first available frequency-domain resource.

In some possible embodiments, the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource includes calculating the frequency-domain starting position of the second PUSCH resource. The frequency-domain starting position of the second PUSCH resource is calculated by subtracting the frequency-domain starting position of the first available frequency-domain resource from the frequency-domain starting position of the first PUSCH resource to obtain a first calculation result; adding the frequency offset to the first calculation result to obtain a second calculation result; and performing a modulo operation on the second calculation result and the size of the first available frequency-domain resource.

In some possible embodiments, the frequency offset ranges from 1 to the size of the first available frequency-domain resource minus 1.

In some possible embodiments, the frequency offset is determined according to the size of the first available frequency-domain resource.

In some possible embodiments, the frequency offset being determined according to the size of the first available frequency-domain resource includes: the frequency offset being one of the following: one half of the size of the first available frequency-domain resource, one quarter of the size of the first available frequency-domain resource, and one eighth of the size of the first available frequency-domain resource.

In some possible embodiments, the frequency offset is indicated by higher-layer information or DCI.

In some possible embodiments, the frequency-domain starting position of the first PUSCH resource is located in a second available frequency-domain resource, and the frequency-domain starting position of the second PUSCH resource is located in a third available frequency-domain resource; and the second available frequency-domain resource and the third available frequency-domain resource are different two available frequency-domain resources or the same available frequency-domain resource.

In some possible embodiments, the third available frequency-domain resource has a largest size among the multiple available frequency-domain resources except the second available frequency-domain resource.

### IX. Exemplary Description of Terminal Device

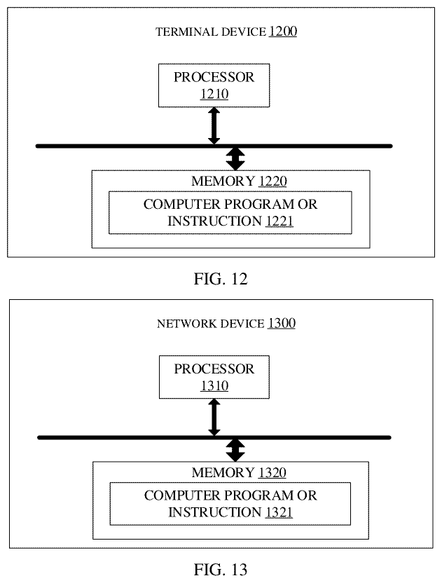

Refer to FIG. 12, where FIG. 12 is a schematic structural diagram of a terminal device 1200 provided in an embodiment of the disclosure. The terminal 1200 includes a processor 1210, a memory 1220, and a communication bus configured to connect the processor 1210 with the memory 1220.

In some possible embodiments, the memory 1220 includes, but is not limited to, a random access memory (RAM), a read-only memory (ROM), an erasable programmable ROM (EPROM), or a compact disc (CD)-ROM. The memory 1220 is configured to store program codes executed by the terminal device 1200 and data transmitted by the terminal device 1200.

In some embodiments the terminal device 1200 further includes a communication interface, where the communication interface is configured to receive and send data.

In some possible embodiments, the processor 1210 may be one or more CPUs. In the case that the processor 1210 is a CPU, the CPU may be implemented as a single-core CPU or multi-core CPU.

In some possible embodiments, the processor 1210 may be a baseband chip, a CPU, a general-purpose processor, a DSP, an ASIC, an FPGA, or other programmable logic devices, transistor logic devices, hardware components, or a combination thereof.

In specific implementation, the processor 1210 of the terminal device 1200 is configured to execute computer programs or instructions 1221 stored in the memory 1220 to send PUSCH on a first PUSCH resource; and send the PUSCH on a second PUSCH resource, where the second PUSCH resource is obtained by performing frequency hopping on the first PUSCH resource. A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

In embodiments of the present disclosure, a new frequency-domain resource allocation method is introduced, that is, multiple frequency-domain resources are allocated to one-time unit, and the multiple frequency-domain resources include at least one uplink frequency-domain resource and at least one downlink frequency-domain resource. In order to avoid that the second PUSCH resource may go beyond available frequency-domain resources (an available frequency-domain resource being an uplink frequency-domain resource allocated thereto among the multiple frequency-domain resources), to be located in unavailable frequency-domain resources (the unavailable frequency-domain resources being downlink frequency-domain resources among the multiple frequency-domain resources and uplink frequency-domain resources allocated to other terminal devices), which may result in that the terminal device is unable to send PUSCH on the first PUSCH resource and/or the second PUSCH resource, that is, the terminal device is unable to send PUSCH through PUSCH frequency hopping, in embodiments of the present disclosure, both the frequency-domain starting position of the first PUSCH resource and the frequency-domain starting position of the second PUSCH resource are located in an available frequency-domain resource. Since the frequency-domain starting position of the second PUSCH resource is located in an available frequency-domain resource, that is, the range of frequency-domain resources for PUSCH frequency hopping in the multiple frequency-domain resources is limited, the second PUSCH resource may be used normally for communication, thereby solving the problem of how to perform PUSCH frequency hopping under the new frequency-domain resource allocation, and ensuring the PUSCH transmission. It may be noted that for specific implementation of each operation, reference can be made to the corresponding description of the above method embodiments. The terminal device 1200 may be configured to perform the above method embodiments of the disclosure, which is not repeated.

In some possible embodiments, the frequency-domain starting position of the first PUSCH resource and the frequency-domain starting position of the second PUSCH resource are located in the same or different available frequency-domain resources.

In some possible embodiments, both the frequency-domain starting position of the first PUSCH resource and the frequency-domain starting position of the second PUSCH resource are located in a first available frequency-domain resource.

In some possible embodiments, the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource; and the frequency offset is an interval between the frequency-domain starting position of the first PUSCH resource in the first available frequency-domain resource and the frequency-domain starting position of the second PUSCH resource in the first available frequency-domain resource.

In some possible embodiments, the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource includes calculating the frequency-domain starting position of the second PUSCH resource. The frequency-domain starting position of the second PUSCH resource is calculated by subtracting the frequency-domain starting position of the first available frequency-domain resource from the frequency-domain starting position of the first PUSCH resource to obtain a first calculation result; adding the frequency offset to the first calculation result to obtain a second calculation result; and performing a modulo operation on the second calculation result and the size of the first available frequency-domain resource.

In some possible embodiments, the frequency offset ranges from 1 to the size of the first available frequency-domain resource minus 1.

In some possible embodiments, the frequency offset is determined according to the size of the first available frequency-domain resource.

In some possible embodiments, the frequency offset being determined according to the size of the first available frequency-domain resource includes the frequency offset being one of the following: one half of the size of the first available frequency-domain resource, one quarter of the size of the first available frequency-domain resource, and one eighth of the size of the first available frequency-domain resource.

In some possible embodiments, the frequency offset is indicated by higher-layer information or DCI.

In some possible embodiments, the frequency-domain starting position of the first PUSCH resource is located in a second available frequency-domain resource, and the frequency-domain starting position of the second PUSCH resource is located in a third available frequency-domain resource; and the second available frequency-domain resource and the third available frequency-domain resource are different two available frequency-domain resources or the same available frequency-domain resource.

In some possible embodiments, the third available frequency-domain resource has a largest size among the multiple available frequency-domain resources except the second available frequency-domain resource.

### X. Exemplary Description of Network Device

Refer to FIG. 13, where FIG. 13 is a schematic structural diagram of a network device provided in an embodiment of the disclosure. The network device 1300 includes a processor 1310, a memory 1320, and a communication bus configured to connect the processor 1310 with the memory 1320.

In some possible embodiments, the memory 1320 includes, but is not limited to, an RAM, an ROM, an EPROM, or a CD-ROM. The memory 1320 is configured to store relevant instructions and data.

In some possible embodiments, the terminal 1300 further includes a communication interface, where the communication interface is configured to receive and send data.

In some possible embodiments, the processor 1310 may be one or more CPUs. In the case that the processor 1310 is a CPU, the CPU may be implemented as a single-core CPU or multi-core CPU.

In some possible embodiments, the processor 1310 may be a baseband chip, a CPU, a general-purpose processor, a DSP, an ASIC, an FPGA, or other programmable logic devices, transistor logic devices, hardware components, or a combination thereof.

In some possible embodiments, the processor 1310 of the network device 1300 is configured to execute computer programs or instructions 1121 stored in the memory 1320 to receive PUSCH on a first PUSCH resource; and receiving the PUSCH on a second PUSCH resource, where the second PUSCH resource is obtained by performing frequency hopping on the first PUSCH resource. A frequency-domain starting position of the first PUSCH resource and a frequency-domain starting position of the second PUSCH resource are both located in an available frequency-domain resource, an available frequency-domain resource in a time unit is an uplink frequency-domain resource among multiple frequency-domain resources in the time unit, the multiple frequency-domain resources include at least one uplink frequency-domain resource and at least one downlink frequency-domain resource, the at least one uplink frequency-domain resources each is contiguous in frequency domain, and the at least one downlink frequency-domain resources each is contiguous in frequency domain.

In embodiments of the present disclosure, a new frequency-domain resource allocation method is introduced, that is, multiple frequency-domain resources are allocated to one-time unit, and the multiple frequency-domain resources include at least one uplink frequency-domain resource and at least one downlink frequency-domain resource. In order to avoid that the second PUSCH resource may go beyond available frequency-domain resources (an available frequency-domain resource being an uplink frequency-domain resource allocated thereto among the multiple frequency-domain resources), to be located in unavailable frequency-domain resources (the unavailable frequency-domain resources being downlink frequency-domain resources among the multiple frequency-domain resources and uplink frequency-domain resources allocated to other terminal devices), which may result in that the terminal device is unable to send PUSCH on the first PUSCH resource and/or the second PUSCH resource, that is, the terminal device is unable to send PUSCH through PUSCH frequency hopping, in embodiments of the present disclosure, both the frequency-domain starting position of the first PUSCH resource and the frequency-domain starting position of the second PUSCH resource are located in an available frequency-domain resource. Since the frequency-domain starting position of the second PUSCH resource is located in an available frequency-domain resource, that is, the range of frequency-domain resources for PUSCH frequency hopping in the multiple frequency-domain resources is limited, the second PUSCH resource may be used normally for communication, thereby solving the problem of how to perform PUSCH frequency hopping under the new frequency-domain resource allocation, and ensuring the PUSCH transmission. It may be noted that for specific implementation of each operation, reference can be made to the corresponding description of the above method embodiments. The network device 1300 may be configured to perform the above method embodiments of the disclosure, which is not repeated.

In some possible embodiments, the frequency-domain starting position of the first PUSCH resource and the frequency-domain starting position of the second PUSCH resource are located in the same or different available frequency-domain resources.

In some possible embodiments, both the frequency-domain starting position of the first PUSCH resource and the frequency-domain starting position of the second PUSCH resource are located in a first available frequency-domain resource.

In some possible embodiments, the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource; and the frequency offset is an interval between the frequency-domain starting position of the first PUSCH resource in the first available frequency-domain resource and the frequency-domain starting position of the second PUSCH resource in the first available frequency-domain resource.

In some possible embodiments, the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource includes: calculating the frequency-domain starting position of the second PUSCH resource. The frequency-domain starting position of the second PUSCH resource is calculated by subtracting the frequency-domain starting position of the first available frequency-domain resource from the frequency-domain starting position of the first PUSCH resource to obtain a first calculation result; adding the frequency offset to the first calculation result to obtain a second calculation result; and performing a modulo operation on the second calculation result and the size of the first available frequency-domain resource.

In some possible embodiments, the frequency offset ranges from 1 to the size of the first available frequency-domain resource minus 1.

In some possible embodiments, the frequency offset is determined according to the size of the first available frequency-domain resource.

In some possible embodiments, the frequency offset being determined according to the size of the first available frequency-domain resource includes the frequency offset being one of the following: one half of the size of the first available frequency-domain resource, one quarter of the size of the first available frequency-domain resource, and one eighth of the size of the first available frequency-domain resource.

In some possible embodiments, the frequency offset is indicated by higher-layer information or DCI.

In some possible embodiments, the frequency-domain starting position of the first PUSCH resource is located in a second available frequency-domain resource, and the frequency-domain starting position of the second PUSCH resource is located in a third available frequency-domain resource; and the second available frequency-domain resource and the third available frequency-domain resource are different two available frequency-domain resources or the same available frequency-domain resource.

In some possible embodiments, the third available frequency-domain resource has a largest size among the multiple available frequency-domain resources except the second available frequency-domain resource.

### XI. Exemplary Description of Other Relevant Contents

In some possible embodiments, the method embodiments described above can be applied to or within a terminal device. That is to say, an execution subject of the foregoing method embodiment may be a terminal device, and may be a chip, a chip module, or a module, which is not specifically limited herein.

In some possible embodiments, the method embodiments described above can be applied to or within a network device. That is to say, an execution subject of the foregoing method embodiment may be a network device, and may be a chip, a chip module, or a module, which is not specifically limited herein.

A chip is further provided in embodiments of the disclosure. The chip includes a processor, a memory, and computer programs or instructions stored in the memory. The processor is configured to execute the computer programs or instructions to implement the operations described in the above method embodiments.

A chip module is further provided in embodiments of the disclosure. The chip module includes a transceiver component and a chip. The chip includes a processor, a memory, and computer programs or instructions stored in the memory. The processor is configured to execute the computer programs or instructions to implement the operations described in the above method embodiments.

A computer-readable storage medium is further provided in embodiments of the disclosure. The computer-readable storage medium is configured to store computer programs or instructions. The computer programs or instructions are executed to implement the operations described in the above method embodiments.

A computer program product is further provided in embodiments of the disclosure. The computer program product includes computer programs or instructions. The computer programs or instructions are executed to implement the operations described in the above method embodiments.

A communication system is further provided in embodiments of the disclosure. The communication system includes a terminal device and a network device.

It may be noted that, for the sake of simplicity, various embodiments above are described as a series of action combinations. However, it will be appreciated by those skilled in the art that the disclosure is not limited by the sequence of actions described. Some operations in embodiments of the disclosure may be performed in other orders or simultaneously. In addition, it will be appreciated by those skilled in the art that the embodiments described in the specification are preferable embodiments, and the actions, the operations, the modules, and the units involved are not necessarily essential to the disclosure.

In the foregoing embodiments, the description of each embodiment has its own emphasis. For the parts not described in detail in one embodiment, reference may be made to related illustrations in other embodiments.

Steps of the method or algorithm described in embodiments of the present disclosure may be implemented by means of hardware, and may also be implemented by means of software instructions executed by a processor. The software instructions may consist of respective software modules, and the software modules may be stored in random access memory (RAM), flash memory, read-only memory (ROM), erasable programmable ROM (EPROM), electrically erasable programmable ROM (EEPROM), a register, a hard disk, a removable hard disk, a compact disc-read only memory (CD-ROM), or any other forms of storage medium known in the art. An exemplary storage medium is coupled to the processor such that the processor can read information from, and write information to, the storage medium. Certainly, the storage medium may also be a component of the processor, and the processor and the storage medium may be located in an application specific integrated circuit (ASIC). In addition, the ASIC may be located in a UE or a management device. Certainly, the processor and the storage medium may also exist in the UE or the management device as discrete components.

Those skilled in the art will appreciate that, all or part of the methods, the operations, or functions of relevant modules/units described in embodiments of the disclosure can be implemented through software, hardware, firmware, or any other combination thereof. When implemented by software, all or part of the functions can be implemented in the form of a computer program product or can be implemented by executing computer program instructions by the processor. The computer program product includes at least one computer program instruction. The computer program instructions may consist of corresponding software modules, where the software module may be stored in an RAM, a flash memory, an ROM, an EPROM, an electrically EPROM (EEPROM), a register, a hard disk, a mobile hard disk, a CD-ROM, or any other form of storage medium known in the art. The computer program instructions can be stored in a computer-readable storage medium, or transmitted from one computer-readable storage medium to another computer-readable storage medium. For example, the computer program instructions can be transmitted from one website, computer, server, or data center to another website, computer, server, or data center in a wired manner or in a wireless manner. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium, or a semiconductor medium (such as a solid state disk (SSD)), etc.

Each module/unit in the apparatus or product above described in the above embodiments may be a software module/unit, a hardware module/unit, or may be partially a software module/unit and partially a hardware module/unit. For example, for each apparatus and product applied to or integrated into the chip, each module/unit included can be implemented by hardware such as circuits, or part of modules/units included can be implemented by software programs that run on a processor integrated into the chip, and another part (if existing) of modules/units included can be implemented by hardware such as circuits. Similar, for each apparatus and product applied to or integrated into the chip module or each apparatus and product applied to or integrated into the terminal, reference can be made to the above.

The embodiments described above describe in further detail purposes, technical solutions and advantages of the embodiments of the disclosure. It should be understood that, the above is only specific embodiments of embodiments of the disclosure, and are not used to limit the protection scope of embodiments of the disclosure. Any modification, equivalent substitution, improvement, and the like that is made on the basis of technical solutions of embodiments of the disclosure shall be included in the protection scope of embodiments of the disclosure.

1. A communication method, comprising:
sending physical uplink shared channel (PUSCH) on a first PUSCH resource; and
sending the PUSCH on a second PUSCH resource, wherein the second PUSCH resource is obtained by performing frequency hopping on the first PUSCH resource;
wherein a frequency-domain starting position of the first PUSCH resource and a frequency-domain starting position of the second PUSCH resource are both located in an available frequency-domain resource, an available frequency-domain resource in a time unit is an uplink frequency-domain resource among a plurality of frequency-domain resources in the time unit, the plurality of frequency-domain resources comprise at least one uplink frequency-domain resource and at least one downlink frequency-domain resource, the at least one uplink frequency-domain resources each is contiguous in frequency domain, and the at least one downlink frequency-domain resources each is contiguous in frequency domain.

2. The method of claim 1, wherein the frequency-domain starting position of the first PUSCH resource and the frequency-domain starting position of the second PUSCH resource are located in the same or different available frequency-domain resources.

3. The method of claim 1, wherein both the frequency-domain starting position of the first PUSCH resource and the frequency-domain starting position of the second PUSCH resource are located in a first available frequency-domain resource.

4. The method of claim 3, wherein the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource; and
the frequency offset is an interval between the frequency-domain starting position of the first PUSCH resource in the first available frequency-domain resource and the frequency-domain starting position of the second PUSCH resource in the first available frequency-domain resource.

5. The method of claim 4, wherein the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource comprises:
calculating the frequency-domain starting position of the second PUSCH resource, comprising:
subtracting the frequency-domain starting position of the first available frequency-domain resource from the frequency-domain starting position of the first PUSCH resource to obtain a first calculation result;
adding the frequency offset to the first calculation result to obtain a second calculation result; and
performing a modulo operation on the second calculation result and the size of the first available frequency-domain resource.

6. The method of claim 4, wherein the frequency offset ranges from 1 to the size of the first available frequency-domain resource minus 1.

7. The method of claim 4, wherein the frequency offset is determined according to the size of the first available frequency-domain resource.

8. The method of claim 7, wherein the frequency offset being determined according to the size of the first available frequency-domain resource comprises:
the frequency offset being one of the following:
one half of the size of the first available frequency-domain resource, one quarter of the size of the first available frequency-domain resource, and one eighth of the size of the first available frequency-domain resource.

9. The method of claim 4, wherein the frequency offset is indicated by higher-layer information or downlink control information (DCI).

10. The method of claim 1, wherein the frequency-domain starting position of the first PUSCH resource is located in a second available frequency-domain resource, and the frequency-domain starting position of the second PUSCH resource is located in a third available frequency-domain resource; and
the second available frequency-domain resource and the third available frequency-domain resource are different two available frequency-domain resources or the same available frequency-domain resource.

11. The method of claim 10, wherein the third available frequency-domain resource has a largest size among the plurality of available frequency-domain resources except the second available frequency-domain resource.

12. A communication method, comprising:
receiving physical uplink shared channel (PUSCH) on a first PUSCH resource; and
receiving the PUSCH on a second PUSCH resource, wherein the second PUSCH resource is obtained by performing frequency hopping on the first PUSCH resource;
wherein a frequency-domain starting position of the first PUSCH resource and a frequency-domain starting position of the second PUSCH resource are both located in an available frequency-domain resource, an available frequency-domain resource in a time unit is an uplink frequency-domain resource among a plurality of frequency-domain resources in the time unit, the plurality of frequency-domain resources comprise at least one uplink frequency-domain resource and at least one downlink frequency-domain resource, the at least one uplink frequency-domain resources each is contiguous in frequency domain, and the at least one downlink frequency-domain resources each is contiguous in frequency domain.

13. The method of claim 12, wherein the frequency-domain starting position of the first PUSCH resource and the frequency-domain starting position of the second PUSCH resource are located in the same or different available frequency-domain resources.

14. The method of claim 12, wherein both the frequency-domain starting position of the first PUSCH resource and the frequency-domain starting position of the second PUSCH resource are located in a first available frequency-domain resource.

15. The method of claim 14, wherein the frequency-domain starting position of the second PUSCH resource is determined according to at least one of: the frequency-domain starting position of the first PUSCH resource, a frequency-domain starting position of the first available frequency-domain resource, a frequency offset, or a size of the first available frequency-domain resource; and
the frequency offset is an interval between the frequency-domain starting position of the first PUSCH resource in the first available frequency-domain resource and the frequency-domain starting position of the second PUSCH resource in the first available frequency-domain resource.

16. The method of claim 15, wherein the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource comprises:
calculating the frequency-domain starting position of the second PUSCH resource, comprising:
subtracting the frequency-domain starting position of the first available frequency-domain resource from the frequency-domain starting position of the first PUSCH resource to obtain a first calculation result;
adding the frequency offset to the first calculation result to obtain a second calculation result; and
performing a modulo operation on the second calculation result and the size of the first available frequency-domain resource.

17. The method of claim 15, wherein the frequency offset ranges from 1 to the size of the first available frequency-domain resource minus 1.

18-44. (canceled)

45. A terminal device, comprising a processor, a memory, and a computer program or instruction stored in the memory, wherein the processor is configured to execute the computer program or instruction to:
send physical uplink shared channel (PUSCH) on a first PUSCH resource; and
send the PUSCH on a second PUSCH resource, wherein the second PUSCH resource is obtained by performing frequency hopping on the first PUSCH resource;
wherein a frequency-domain starting position of the first PUSCH resource and a frequency-domain starting position of the second PUSCH resource are both located in an available frequency-domain resource, an available frequency-domain resource in a time unit is an uplink frequency-domain resource among a plurality of frequency-domain resources in the time unit, the plurality of frequency-domain resources comprise at least one uplink frequency-domain resource and at least one downlink frequency-domain resource, the at least one uplink frequency-domain resources each is contiguous in frequency domain, and the at least one downlink frequency-domain resources each is contiguous in frequency domain.

46-48. (canceled)

49. The method of claim 4, wherein the frequency-domain starting position of the second PUSCH resource being determined by at least one of: the frequency-domain starting position of the first PUSCH resource, the frequency-domain starting position of the first available frequency-domain resource, the frequency offset, or the size of the first available frequency-domain resource comprises:
calculating the frequency-domain starting position of the second PUSCH resource, comprising:
subtracting the frequency-domain starting position of the first available frequency-domain resource from the frequency-domain starting position of the first PUSCH resource to obtain a first calculation result;
adding the frequency offset to the first calculation result to obtain a second calculation result; and
performing a modulo operation on the second calculation result and the size of the first available frequency-domain resource to obtain a third calculation result; and
adding a frequency-domain starting position of active uplink bandwidth part (UL active BWP) to the third result.

50. The method of claim 7, wherein the frequency offset is a frequency offset corresponding to a PUSCH scheduled by random access response (RAR) uplink (UL) grant, or a frequency offset corresponding to a PUSCH scheduled by DCI 0-0 scrambled by temporary cell radio network temporary identity (TC-RNTI).
